(19) United States
(12) Patent Application Publication
(10) Pub. No.: US 2026/0050249 A1
(43) Pub. Date: Feb. 19, 2026

(54) Topology-Based Programming of Thermo-Active Substances

(71) Applicant: The Board of Trustees of the University of Illinois, Urbana, IL (US)

(72) Inventors: Xiaojia Zhang, Urbana, IL (US); Weichen Li, Urbana, IL (US); Yibo Wang, Urbana, IL (US)

(21) Appl. No.: 19/297,580

(22) Filed: Aug. 12, 2025

Related U.S. Application Data
(60) Provisional application No. 63/682,612, filed on Aug. 13, 2024.

(51) Int. Cl. G05B 19/4097; G06F 30/23; G06F 113/10

(52) U.S. Cl. CPC G05B 19/4097; G06F 30/23; G06F 2113/10

(57) ABSTRACT

An example embodiment includes: obtaining a specification of a target deformation shape for a substance, wherein the substance has a plurality of material control points with respective curvatures and arc lengths defining the target deformation shape, and wherein the substance includes thermo-active components and non-thermo-active components; determining a set of relations between indications of presence of the thermo-active components or the non-thermo-active components, orientations of the thermo-active components, and deformation capabilities of the thermo-active components; providing, to an optimization solver application, the specification, the set of relations, and instructions to determine values of the presence of the thermo-active components or the non-thermo-active components within the locations of the target deformation shape and the orientations of the thermo-active components, such that the substance can attain the target deformation shape in response to a temperature change when in a non-deformed state; and receiving, from the optimization solver application, the values as determined.

### CROSS-REFERENCE TO RELATED APPLICATION

This application claims priority to U.S. provisional patent application No. 63/682,612, filed Aug. 13, 2024, which is hereby incorporated by reference in its entirety.

### GOVERNMENT LICENSE RIGHTS

This invention was made with government support under contracts 2047692 and 2245251 awarded by the National Science Foundation. The government has certain rights in the invention.

### BACKGROUND

Four-dimensional (4D) printing is similar to three-dimensional (3D) printing but with materials that change over time in response to stimulus. The field is exhibiting significant potential in applications such as self-repairing systems, self-assembly, self-reconfigurable proteins for the medical industry, smart fabrics and fashion, artificial tissue, and skin temperature-actuated smart medical products as just a few examples. Thermally active composite materials made of liquid crystal elastomers (LCEs) are one potential material for 4D printing. LCEs are cross-linked polymer networks, which are known for their responsive deformation capacity. While LCEs have been known to respond to temperature and light, their practical uses have not been explored. Thus, existing techniques for employing LCE are oversimplified and have resulted in unreliable designs or assume inaccurate deformation capabilities.

### SUMMARY

The embodiments herein include algorithms that program thermally active material and have precise control over their temperature-active mechanical behavior. These embodiments may employ a continuum model of LCEs which is based on the mechanics of LCE microstructures that accurately capture the temperature-induced shape changes of LCEs. The embodiments incorporate a rigorous nonlinear LCE model with multimaterial topology optimization and specific optimization formulations. This is the first model to consider both material and geometric nonlinearity in LCEs for a wide range of extreme functionalities. The resulting designs exhibit highly irregular material distributions, which surpass intuition-based designs, and precisely produce desired deformed geometries upon temperature change.

The disclosed embodiments provide technical improvements to computing systems and manufacturing processes for thermo-active substances. Among other aspects, these embodiments include improved computational methods for the inverse design of soft structures made of, for example, LCEs, that spontaneously morph into arbitrarily complex geometries upon temperature change. Unlike prior approaches that rely on heuristic design or limited modeling, these embodiments involve a finite-deformation, multiphysics topology framework to systematically determine the spatial distribution and director orientation of LCEs needed to produce desired deformed shapes. Technical improvements can be found in the use of a curvature-based objective formulation that is both rotation-invariant and size-insensitive, enabling robust shape programming even under large, nonlinear deformations.

The continuum model of LCE behavior, accounts for anisotropic elasticity, temperature-dependent phase transitions, and semi-soft mechanical responses. It further integrates a multimaterial interpolation method to handle multiple candidate configurations and a passive elastomeric phase, allowing for flexible and precise control over actuation behavior. As a result, the system can generate LCE designs that morph into intricate shapes with high fidelity. This represents a significant technical advance over prior art by enabling deterministic, accurate, and efficient design of programmable soft actuators and morphing structures.

Additional embodiments provide a topology optimization framework with free-form and continuous LCE director distributions that are suitable for Direct Ink Writing (DIW). The framework is built upon a rigorous model that accurately captures LCE's large thermal deformations, with a novel continuation filtering technique to realign LCE directors smoothly, accounting for LCE's unique physical properties. With the proposed method, several optimization formulations can be used to design various complex and intriguing LCE behaviors under temperature changes, including programmable complex shape morphing, inducing desired strains, and achieving non-monotonic thermal expansion-contraction under a monotonic temperature rise. The optimized LCE designs successfully achieve versatile desired functionalities while featuring a continuous director distribution suitable for DIW fabrication.

A system of one or more computers or computing systems can be configured to perform particular operations or actions by virtue of having software, firmware, hardware, or a combination thereof installed that in operation causes or cause the computer(s) or systems(s) to perform the actions. One or more computer programs can be configured to perform particular operations or actions by virtue of including instructions that, when executed by data processing apparatus, cause the apparatus to perform the actions.

One general aspect involves a method. The method includes: obtaining a specification of a target deformation shape for a substance, where the substance has a plurality of material control points with respective curvatures and arc lengths defining the target deformation shape, and where the substance includes thermo-active components and non-thermo-active components. The method also includes determining a set of relations between indications of presence of the thermo-active components or the non-thermo-active components within locations of the target deformation shape, orientations of the thermo-active components where present, and deformation capabilities of the thermo-active components where present. The method also includes providing, to an optimization solver application, the specification, the set of relations, and instructions to determine values of the presence of the thermo-active components or the non-thermo-active components within the locations of the target deformation shape and the orientations of the thermo-active components where present, such that the substance can attain the target deformation shape in response to exposure to a temperature change when in a non-deformed state. The method also includes receiving, from the optimization solver application, the values as determined. The method also includes providing, to a manufacturing system, a digital model of the substance in the non-deformed state including the values, where the manufacturing system is configured to produce a physical representation of the substance in the non-deformed state.

A further general aspect includes another method. The method includes obtaining a specification of a target deformation shape for a substance, where the substance has a plurality of material control points with respective curvatures and ac lengths defining the target deformation shape, and where the substance includes thermo-active components and non-thermo-active components. The method also includes determining a set of relations between indications of presence of the thermo-active components or the non-thermo-active components within locations of the target deformation shape, orientations of the thermo-active components where present, and deformation capabilities of the thermo-active components where present. The method also includes providing, to an optimization solver application, the specification, the set of relations, and instructions to minimize a curvature-based error function between a current deformation shape of the substance and the target deformation shape. The method also includes receiving, from the optimization solver application, values of the presence of the thermo-active components or the non-thermo-active components within the locations of the target deformation shape and the orientations of the thermo-active components where present, such that the substance can attain the target deformation shape in response to exposure to a temperature change when in a non-deformed state. The method also includes providing, to a manufacturing system, a digital model of the substance in the non-deformed state including the values, where the manufacturing system is configured to produce a physical representation of the substance in the non-deformed state.

Other embodiments include corresponding computer system(s), apparatus(es), and computer program(s) recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts 3D and 4D printing processes, in accordance with example embodiments.

FIG. 4 depicts programming thermo-active behaviors of LCE composites, in accordance with example embodiments.

FIG. 5 depicts semi-soft elasticity predictions, in accordance with example embodiments.

FIG. 6 depicts an inverse optimization formulation, in accordance with example embodiments.

FIG. 7 depicts an inverse optimization of a strip LCE composite, in accordance with example embodiments.

FIG. 8 depicts a parametric representation and realization of different target shapes, in accordance with example embodiments.

FIG. 9 depicts an inverse optimization of LCE sheet to realize circular and elliptical deformed shapes, in accordance with example embodiments.

FIG. 10 depicts an inverse optimization of LCE sheet to realize target deformed shapes, in accordance with example embodiments.

FIG. 11 depicts an inverse optimization of openings inside LCE sheets to realize target deformed shapes, in accordance with example embodiments.

FIG. 12 depicts a topology optimization of an LCE actuator with maximized output displacement, in accordance with example embodiments.

FIG. 13 is a flow chart, in accordance with example embodiments.

FIG. 14 depicts LCE designs with continuous director orientation, in accordance with example embodiments.

FIG. 15 depicts a director orientation continuation filter for LCE design, in accordance with example embodiments.

FIG. 16 depicts optimized LCE designs with continuous director orientation, in accordance with example embodiments.

FIG. 17 depicts optimized LCE structures with continuous director orientation, in accordance with example embodiments.

FIG. 18 depicts optimized LCE designs to induce desired strain values, in accordance with example embodiments.

FIG. 19 depicts an optimization history, in accordance with example embodiments.

FIG. 20 depicts optimized designs targeting various straining modes, in accordance with example embodiments.

FIG. 21 depicts LCE designs targeting non-monotonic thermal-induced expansion-contraction under monotonic temperature increase, in accordance with example embodiments.

FIG. 22 is a flow chart, in accordance with example embodiments.

FIG. 23 depicts LCE with various programmed temperature-adaptive functionalities, in accordance with example embodiments.

FIG. 24 depicts LCE metamaterial with maximized temperature-induced area expansion, in accordance with example embodiments.

FIG. 25 depicts LCE metamaterial with precisely programmed temperature-induced change of an opening's area, in accordance with example embodiments.

FIG. 26 depicts LCE metamaterial with programmable temperature-switchable nonlinear stress-strain relations, in accordance with example embodiments.

FIG. 27 depicts LCE metamaterial with temperature-switchable and nonlinear lateral deformation modes, in accordance with example embodiments.

### DETAILED DESCRIPTION

Example methods, devices, and systems are described herein. The words “example” and “exemplary” are used to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. The aspects of the present disclosure can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

Herein, a “software application” may be any structured set of computer-executable instructions that can perform a specific function or a set of related functions. This encompasses programs that operate in various computing environments, including but not limited to standalone desktop applications, mobile applications, web-based applications, embedded systems software, cloud-based services, distributed computing applications, and operating systems. Software applications may involve the processing, manipulation, and management of data, control of hardware devices, execution of various algorithms, provisioning of user interfaces for interaction, and communication with other software applications or services. The term is inclusive of software that performs an array of functions, whether pre-installed, downloaded, accessed remotely, or delivered as a service. This definition is intended to cover a broad range of software implementations, architectures, and platforms, recognizing the evolving nature of technology and software development practices.

Furthermore, herein the terms “optimize,” “maximize,” “minimize,” and any related expressions are not to be construed as indicating that the disclosed embodiments necessarily achieve the absolute best possible outcomes according to these criteria. Instead, these terms should be interpreted as representing objectives or goals that the embodiments aim to achieve to varying degrees under certain conditions. The use of such terms is intended to describe general intents or directions, rather than a definitive statement of performance.

Moreover, the effectiveness and efficiency of the embodiments herein may vary based on a multitude of factors, including but not limited to the specific application, operating environment, and the precise configuration thereof. As such, while the embodiments may strive to optimize, maximize, or minimize certain parameters in certain scenarios, it is not guaranteed that the results will always represent the highest degree of optimization, maximization, or minimization possible. Instead, these terms should be understood as conveying the intent to improve or enhance certain aspects relative to a baseline or comparative state.

Therefore, the scope of these embodiments should not be limited or interpreted to imply that they always deliver the optimal, maximal, or minimal outcomes. Rather, the embodiments are intended to offer improvements or enhancements in alignment with the stated objectives, recognizing that such improvements may be context-dependent and subject to practical limitations. The discussion herein should be understood and interpreted with this perspective in mind, so that this broad and flexible nature is appropriately appreciated.

Herein variables representing vector, matrix, and tensor values are not given any special designation (such as bold text). Instead, such variables can be differentiated from scalar values based on context and the understanding of one of ordinary skill in the art.

### I. Example Computing Devices and Cloud-Based Computing Environments

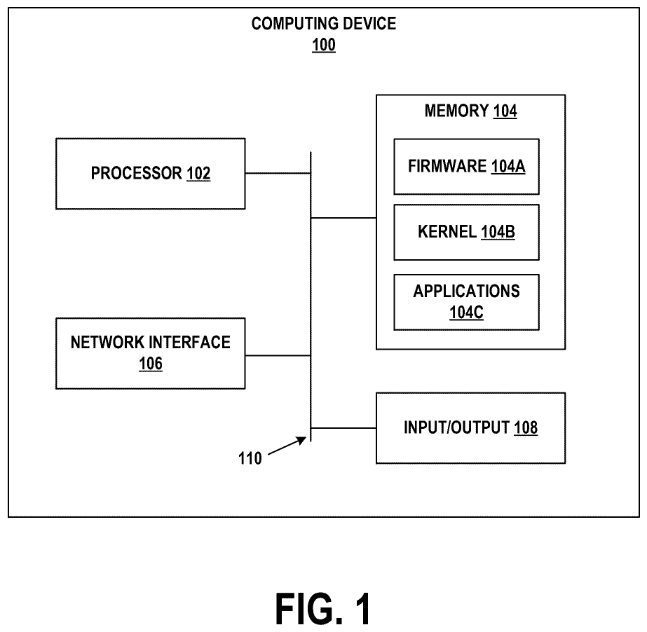

FIG. 1 is a simplified block diagram of an example computing device 100, illustrating some of the components that could be included in a computing device configured to operate in accordance with the embodiments herein. Computing device 100 may be a client device (e.g., a device actively operated by a user), a server device (e.g., a device that provides computational services to client devices), or some other type of computational platform. Some server devices may operate as client devices from time to time to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, video screens, and so on).

Processor 102 may be one or more of any type of computer processing element, such as a central processing unit (CPU), graphical processing unit (GPU), digital signal processor (DSP), network processor, encryption processor, and/or other integrated circuit or controller capable of performing processor operations. In some embodiments, processor 102 may comprise one or more single-core or multi-core processors, with each core representing an independent processing unit. Processor 102 may also include register memory for temporarily storing instructions and related data, and cache memory for temporarily storing recently used instructions and data.

GPUs may include specialized circuitry designed to perform rapid mathematical calculations for rendering graphics, processing large datasets, and supporting machine learning. A GPU may include a large number of small processing cores that operate in parallel, facilitating the decomposition of tasks into smaller units that can be processed concurrently. This parallelism may allow GPUs to outperform traditional CPUs for certain classes of computational tasks (though CPUs may also support forms of parallelism at the core or instruction level).

Memory 104 may include any form of computer-usable memory, including but not limited to random access memory (RAM), read-only memory (ROM), and non-volatile memory such as hard disk drives, solid state drives, compact discs (CDs), digital video discs (DVDs), and/or magnetic tape storage. Memory 104 may therefore include both volatile and non-volatile memory components. Any non-volatile memory may also be referred to as persistent storage. Memory 104 may store program instructions and/or data on which the program instructions operate. For example, memory 104 may store instructions on a non-transitory, computer-readable medium, where the instructions are executable by processor 102 to perform any of the methods or operations described herein.

As shown in FIG. 1, memory 104 may include firmware 104A, kernel 104B, and/or applications 104C. Firmware 104A may comprise program code used to initialize computing device 100. Kernel 104B may include an operating system with modules for memory management, process scheduling, input/output handling, and device communication. Kernel 104B may also include device drivers that enable the operating system to interface with hardware components. Applications 104C may include user-space software such as web browsers, email clients, web servers, and/or software libraries.

Network interface 106 may include one or more wireline interfaces, such as Ethernet (e.g., Gigabit Ethernet, 10 Gigabit Ethernet, Ethernet over fiber). Network interface 106 may also support one or more non-Ethernet communication media, including wireless protocols such as Wi-Fi (e.g., IEEE 802.11), Bluetooth (IEEE 802.15.1), cellular (e.g., 3G, 4G LTE, 5G NR), and Zigbee (IEEE 802.15.4). Other supported interfaces may include Near Field Communication (NFC), infrared (IrDA), Universal Serial Bus (USB)-based network adapters, and/or High-Definition Multimedia Interface (HDMI) connectors. Additional or alternative interfaces may be used.

Input/output unit 108 may facilitate interaction between computing device 100 and peripheral devices or users. The input/output unit may include input devices such as keyboards, mice, and touchscreens, and output devices such as monitors, printers, or light-emitting diodes (LEDs). Computing device 100 may communicate with these types of devices using a port configured to support USB or HDMI for example.

In some embodiments, one or more computing devices such as computing device 100 may be deployed off-premises. The physical location, network configuration, and/or internal topology of these devices may not be apparent to client devices. Accordingly, such devices may be implemented as cloud-based computing platforms residing in one or more data center environments.

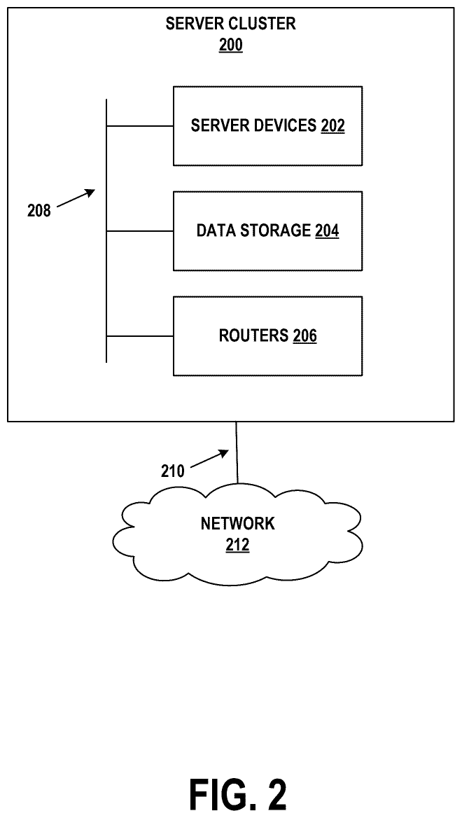

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, instances data storage 204, and routers 206 in server cluster 200 may depend on the computing task(s) and/or applications assigned to server cluster 200.

For example, server devices 202 may be configured to perform various computing tasks of computing device 100. Thus, computing tasks can be distributed among one or more of server devices 202. To the extent that these computing tasks are performed in parallel, such a distribution of tasks may reduce the total time to complete these tasks and return a result. For purposes of simplicity, both server cluster 200 and individual server devices 202 may be referred to as a “server device.” This nomenclature should be interpreted to encompass configurations involving one or more distinct server devices, data storage systems, and cluster-level routing components, and should be interpreted to encompass any such configurations.

Data storage 204 may include data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to mitigate data loss due to drive failures or other system faults. Other types of memory devices, aside from drives, may be used.

Routers 206 may include networking equipment configured to provide internal and external communications for server cluster 200. For example, routers 206 may include one or more network-layer switching or routing components (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be implemented as monolithic systems or distributed across multiple physical or virtualized storage resources.

Server devices 202 may be configured to transmit data to and receive data from data storage 204. This transmission and retrieval may take the form of SQL queries or other types of database queries, and the output of such queries, respectively. Additional content, such as text, images, video, and/or audio may be included as well. Furthermore, server devices 202 may organize the received data into web pages or web application representations. Such a representation may take the form of a markup language, such as HTML, XML, JSON, or some other standardized or proprietary format. Moreover, server devices 202 may have the capability of executing various types of computerized scripting languages, including but not limited to Perl, Python, PHP Hypertext Preprocessor (PHP), Active Server Pages (ASP), JavaScript, and so on. Computer program code written in these languages may facilitate the provision of web pages to client devices, as well as client device interaction with the web pages. Alternatively or additionally, Java may be used to facilitate the generation of web pages and/or to provide web application functionality with dynamic content handling.

### II. Example Framework for 3D and 4D Printing

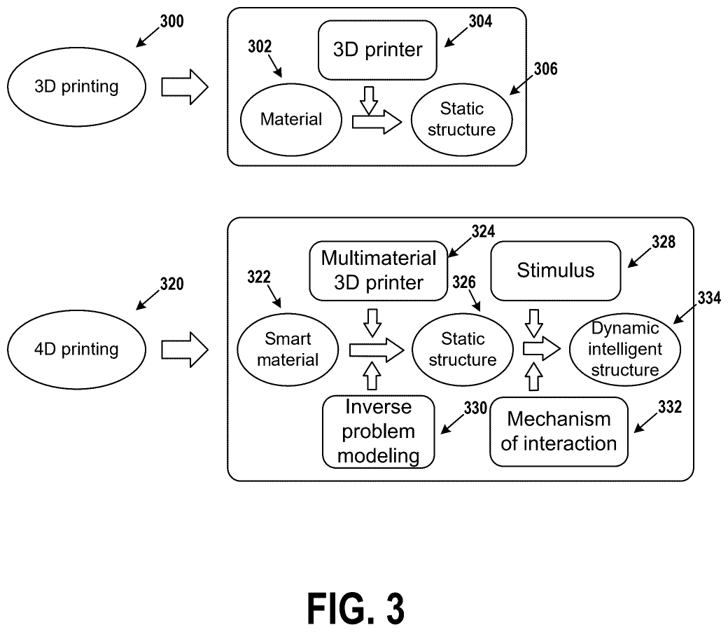

FIG. 3 depicts the differences between an example process 300 for 3D printing and an example process 320 for 4D printing processes. In the 3D printing, the process 300 begins with a material 302 that is fed into a 3D printer 304, which constructs a static structure 306 as the final output. Thus, 3D printing is a comparatively straightforward transformation from raw material to a non-dynamic, fixed form.

In contrast, 4D printing introduces additional complexities. It starts with smart material 322, which is processed by a multimaterial 3D printer 324. The initial output is still a static structure 326, but unlike in 3D printing, a stimulus 328 can be applied to static structure 326. Inverse problem modeling 330 can be used to predict the behavior of the smart material 322, while a mechanism of interaction 332 facilitates the response of static structure 326 to external stimuli (e.g., stimulus 328). As a result, the output is a dynamic intelligent structure 334, capable of changing its properties or shape in response to the environment. In this fashion, 4D printing has the ability to produce objects that can adapt and transform over time.

The embodiments herein introduce programmable thermal-actuated active materials and structures that enable versatility and precise control over their temperature-active mechanical behaviors. The composite materials can be made of liquid crystal elastomer (LCE), which is a type of anisotropic and thermal-active soft material, and a passive isotropic elastomer such as rubber. One aspect of these embodiments lies in the design algorithm to synthesize these thermo-active composites. The algorithm is built upon topology optimization and simultaneously optimizes the geometry and LCE material distributions of the composites to synthesize designs with any prescribed thermo-active or thermo-adaptive behaviors and actuations, such as a sheet morphing into any complex target shapes under increasing temperature or programmable porosity of a sheet to any desired levels, while taking into account temperature-switchable nonlinear stress-strain relations and deformation modes.

The embodiments address the challenges of how to systematically inverse design or program the thermal-active behaviors of LCE composites. Doing so offers many new design patterns and enables highly complex yet precisely controllable active behaviors that are beyond the capacity of existing design approaches. The applications of this technology are diverse and far-reaching, including environmentally active and adaptive smart materials/structures, smart fabrics for active thermal management, smart medical products for wound closure, situation-aware metamaterials, and more.

As an example, fabrics made of the programmed LCE composites can adaptively change their porosity based on ambient temperatures. This enables active thermal management for the wearer, reducing heat loss when cold and facilitating heat dissipation when hot with a high control precision. Specifically, a rise in temperature may increase porosity and heat dissipation from human body, and a drop in temperature may decrease porosity and keep the wearer warm. Another example relates to bandages for active wound closure. The technology enables skin-temperature activated contraction of smart bandages that can apply and keep a contraction force on wounds and accelerate their recovery. Yet another example involves thermomechanical actuators with customizable output force, displacement, and work. These materials can be used for temperature-related control systems and sensors.

These embodiments are different from and provide advantages over prior techniques. The known methods for designing LCE structures and behaviors fall into two categories: intuition-based approaches and optimization-guided methods.

Intuition-based approaches primarily rely on human experience to generate designs in a forward and trial-and-error fashion. There are three drawbacks to such approaches. First, the design patterns and the resulting behaviors are limited to simple ones, and the more complex responses are usually not attainable. Second, the forward-design nature implies the behaviors cannot be determined a priori and need inefficient trial-and-errors to form the design. Third, the desired behaviors, even if qualitatively achieved, cannot be controlled in a precise manner. In contrast, the embodiments herein are built upon inverse design driven by physics and algorithms and free of human experience or intervention, thereby capable of automatically generating diverse optimized designs and highly sophisticated programmable behaviors far beyond the reach of experience.

The few existing optimization-guided methods for LCE design are built upon overly simplified and non-rigorous material models that cannot accurately capture the critical behaviors of LCE (such as soft elasticity), which in turn lead to unreliable optimized designs. Others have assumed a linear and small-deformation setup that cannot capture LCE's large and highly nonlinear deformations. Also, the optimization formulations are relatively simple and generate mainly simple designs and behaviors. In contrast, the embodiments herein are integrated with a rigorous and advanced model that captures the unique behaviors of LCE and considers both material and geometric nonlinearity to accurately represent the large deformations. Furthermore, the technology includes a comprehensive set of new and sophisticated optimization formulations able to deliver complex thermal-active and thermal-adaptive LCE responses precisely matching the targets prescribed by designers.

### III. Curvature Programming

### A. LCE as a Thermo-Active Material

LCE is a type of soft material that exhibits large and reversible spontaneous deformations under temperature stimuli. This property makes LCE a strong candidate for environmentally responsive structures, such as temperature actuators, morphing structures, soft robotics, smart bio-medical devices, and artificial muscles. Hence, the capacity to inversely program LCE's spontaneous deformation to achieve diverse prescribed behaviors would be desirable.

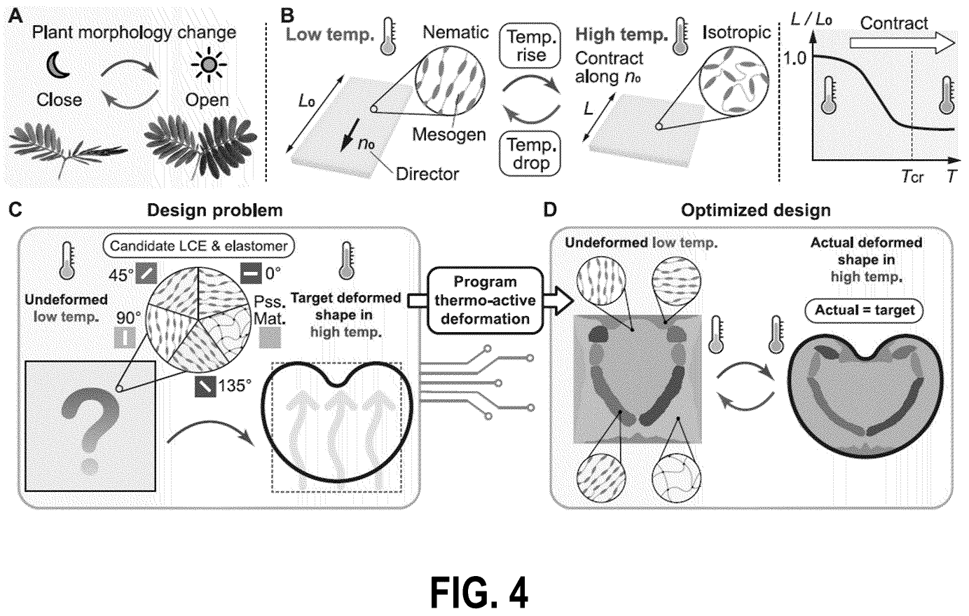

The spontaneous deformation of nematic LCE is caused by the change of molecular orientation orders and can achieve a strain magnitude of over 50%. As illustrated in FIG. 4 part B, LCE consists of rigid rod-like molecules known as mesogens bonded to a lightly crosslinked polymer network. At the nematic phase (low temperature), the mesogens exhibit a statistical orientation order with the average orientation known as the director no. The rise in temperature increases the entropy of the molecules and weakens the orientation order. Beyond a transition temperature T_{cr}, the orientation order is completely lost, and the LCE becomes isotropic. The nematic-isotropic transition is manifested macroscopically as the spontaneous contraction along no. The entropic nature of the response allows for the recovery of the original order and shape when the temperature decreases.

Here, the term “director” refers to the average orientation of the rod-like molecules (mesogens) within the material. It is analogous to an arrow that shows the general direction in which most of these microscopic molecules are aligned. This alignment is not fixed in the material and can change with temperature. That change is what causes the LCE to deform (bend, contract, twist, etc.).

The types and magnitudes of LCE structures' spontaneous deformation are directly determined by the spatial distribution of the director. Different distributions produce distinct morphing patterns. Therefore, applications of LCE involve inversely creating the director distribution for targeted behaviors/functions. Topology optimization is a computational morphogenesis approach that can produce free-form designs achieving optimized user-specified performance, such as maximized stiffness. As LCE's spontaneous deformation is highly complex and fundamentally different from thermal expansion, accurate shape programming through topology optimization requires a rigorous and finite-deformation setup. However, such a method is underdeveloped, impeding full use of LCE's actuation for realizing complex deformed shapes.

The development of a finite-deformation topology optimization framework for programming LCE's deformation should address three challenges. First, how to construct a systematic design characterization framework incorporating rigorous models for LCE's complex behaviors into the optimization. Second, how to realize efficient and stable numerical simulations of LCE's large and highly nonlinear deformation. Third, how to develop a robust optimization formulation that accurately captures the intrinsic features of the deformed shape.

Based on a rigorous LCE model and multiphysics topology optimization, this work develops a free-form inverse optimization framework for systematically programming the deformed shape of LCE composites to achieve prescribed target shapes. Aspects of these embodiments are illustrated in FIG. 4 part C. A goal is to inversely optimize the spatial distribution and director orientation of LCE so that the composite can realize any prescribed shape in its temperature-induced deformed configuration as indicated in FIG. 4 part D. A continuum model of LCE developed based on the statistical mechanics of LCE's microstructures can be adopted. The model accurately captures the temperature-induced anisotropic shape change and (semi-) soft elasticity of LCE. Then, a characterization method is proposed that is based on multimaterial topology optimization that incorporates multiple candidate LCE directors as well as a passive elastomeric material. Based on the characterization method, the inverse optimization formulation is developed for programming arbitrary deformed shapes of LCE. A curvature-based description of the deformed shapes can be used. This description features several advantages for shape programming, such as being rotation-invariant and size-insensitive. With the optimization framework, LCE composites can be inversely programmed to achieve a wide range of complex prescribed target shapes, including—as just some examples—those of numbers, letters, and objects such as an apple and a flower. The optimized designs show highly irregular distributions of LCE directors and accurately achieve the targets. Additionally, optimized LCE actuators under temperature changes are considered and the benefits of a passive material phase in promoting actuation are discussed. The developed framework can benefit the design of a wide range of LCE-related active materials and structures.

### B. A Continuum Model of LCE

The embodiments herein adopt a continuum LCE model. The model is given in the form of a free-energy density function, which, with a fabrication-related condition, reduces to an anisotropic hyperelastic stored-energy density function with temperature dependence. The spontaneous deformation of LCE can be modeled as an anisotropic thermal expansion. Such an approach, however, may not capture the unique soft or semi-soft elasticity of LCE, which could lead to inaccurate estimates of macroscopic responses such as forces and displacements. The embodiments herein adopt a rigorous model derived based on the statistical mechanics of LCE's microstructures, which accurately captures the spontaneous shape change and semi-soft elasticity of LCE.

### 1. Free Energy Density for LCE

Rigorous modeling of LCE's behavior can employ the neo-classical free energy density model. The model is derived based on anisotropic Gaussian rubber considering the orientation order of mesogens. The free-energy density function of the neo-classical model is

$${W}_{NC} ( F , n ) = \frac{μ}{2} Tr [ {l}_{0} {F}^{T} {l}^{- 1} ( n ) F - 3 ] \qquad ( 1 )$$

$$Where$$

$${l}_{0} = a ( ( 1 - {Q}_{0} ) δ + 3 {Q}_{0} {n}_{0} ⊗ {n}_{0}$$

$$And$$

$$l ( n ) = a ( ( 1 - Q ) δ + 3 Qn ⊗ n$$

are initial and current step length tensors that characterize anisotropy, and Q₀, Q∈[0,1] are initial and current order parameters that characterize the orientation order of the mesogens, respectively, and they are determined by the initial and current temperatures; n₀ and n are the initial and current director (unit vector), respectively; α is the step length of the freely-joint chain model; and δ is the Kronecker delta.

Its simple form encodes rich information about LCE behaviors, including spontaneous deformation, soft elasticity, director rotation, and coupled shear deformation when stretched perpendicular to the initial director, which can be observed in experiments and are absent in normal isotropic elastomers. The spontaneous deformation due to temperature change is realized through Q, which depends nonlinearly on the current temperature T.

Equation 1, however, predicts a continuous zero-energy and zero-force soft model, which disagrees with the soft behavior observed in the experiment; the latter exhibits an initial stiff phase for a small strain range followed by a long force plateau with small but non-zero stiffness, then finally ends with a third stiff phase with revived high stiffness. Also, in the case of isotropic-to-nematic transition, the model predicts infinitely many director orientations. These issues would thwart numerical computation. A remedy is the improved semi-soft model that adds to Equation 1 a non-ideal free energy to incorporate the nonideality due to non-uniform cross-linking.

The non-ideal model is expressed as

$${W}_{NI} ( F , n ) = \frac{μ}{2} Tr [ {l}_{0} {F}^{T} {l}^{- 1} ( n ) F - 3 ] + ω \frac{μ}{2} Tr [ ( δ - {n}_{0} ⊗ {n}_{0} ) {F}^{T} n ⊗ n F ] \qquad ( 2 )$$

Where ω is the non-ideality parameter. The W_{N1} term eliminates zero-stiffness soft modes and yields semi-soft responses with small but non-zero stiffness, which agrees with the experiment. The semi-soft stress-stretch curve predicted by Equation 2 in the perpendicular stretch experiment shows the three-stage, stiff-soft-stiff feature. There are more sophisticated models considering additional energy terms depending on the spatial gradient of n, i.e., ∇n, but those terms are of orders of magnitude smaller than the W_{NC} and W_{N1} and require element size in finite element analysis (FEA) to be smaller than a characteristic length at the order of 10 nm, which could be used but are typically impractical, for the applications herein. Equation 2 can accurately predict LCEs behavior not only in the uniaxial loading but also in the biaxial case.

In Equation 2, both F and n are unknown and independent, indicating potential director rotation relative to the deformed matrix. The relative rotation (and overall LCE behaviors) is significantly influenced by the fabrication process and crosslink densities. LCE cross-linked in the nematic phase with relatively low temperature or high crosslink density shows limited relative director rotations and higher stiffness. In this scenario, the director can be assumed “frozen” to the polymer matrix, and the current director n is determined by the macroscopic deformation F and the initial director no through

$$n = \frac{{Fn}_{0}}{\vert {Fn}_{0} \vert} \qquad ( 3 )$$

Equation 3 removes the independence of n and modifies Equation 2 to the following anisotropic stored-energy density function

$${W}_{FZ} ( F ) = \frac{μ}{2} [ \frac{1 - {Q}_{0}}{1 - Q} Tr ( C ) + ( \frac{3 {Q}_{0}}{1 + 2 Q} - ω ) {n}_{0} \cdot {Cn}_{0} - ( \frac{3 Q ( 1 - {Q}_{0} )}{( 1 - Q ) ( 1 + 2 Q )} - ω ) \frac{{n}_{0} \cdot {C}^{2} {n}_{0}}{{n}_{0} \cdot {Cn}_{0}} - 3 ] \qquad ( 4 )$$

Where C:=F^{T}F is the right Cauchy-Green deformation tensor. Equation 4's sole dependence on F considerably reduces computational cost compared to Equation 2.

The nematic genesis needed for the frozen-director condition may not always be preferable for fabrication. For LCE with isotropic genesis where the director can freely rotate, the frozen-director condition could be inappropriate and should be removed, which recovers Equation 4 to Equation 2. In that case, the displacement and director fields are independent and are determined through energy minimization. In addition, a Lagrange multiplier field for the inextensibility constraint of n needs to be solved. Hence, lifting the frozen director condition would increase the computational cost.

### 2. Two-Stage Semi-Soft Elasticity

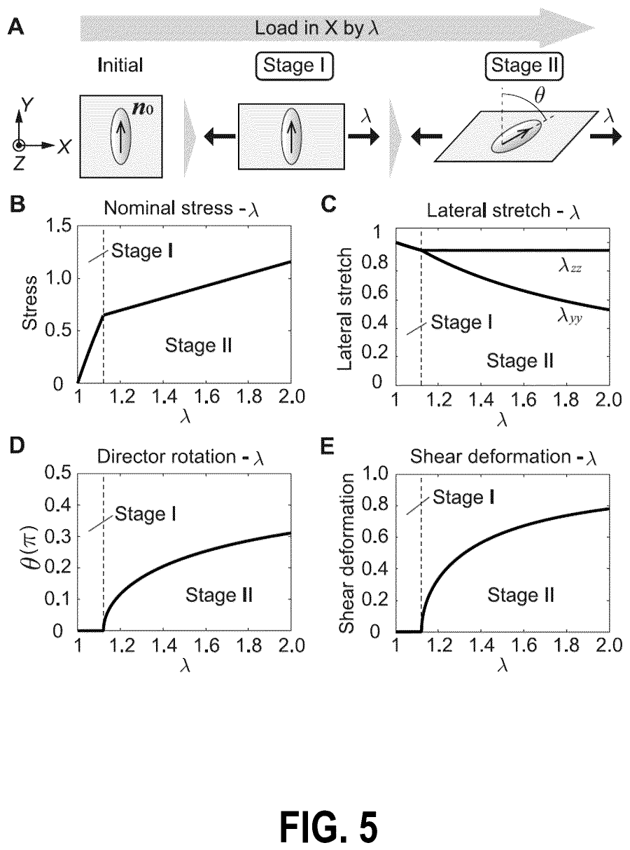

One of the unique features of LCE is that it exhibits (semi-) soft behavior, which can be revealed experimentally through applying stretch perpendicular to the initial director no in an isothermal condition as indicated in FIG. 5 part A. When the LCE sample is stretched, the director remains initially static, but after a critical stretch, the director starts to rotate and coupled shear deformation occurs to achieve a lower energy state. Accompanying the director rotation and shear is the sudden drop of stiffness in the stress-stretch curve, resulting in the soft behavior. When stretched further, depending on how the LCE is made and whether it is modeled with the frozen-director condition, LCE could establish a third stage with revived high stiffness

The frozen-director model of Equation 4 can predict a two-stage semi-soft behavior, which cannot be captured by standard hyperelastic models used in some studies to model LCE. As an example, Equation 4 can be used with μ=2 and ω=0.1 (chosen for better illustration and only for this theoretical analysis, not for the material parameters used in the examples) and a deformation gradient F chosen to represent the kinematics of the stretch experiment. The obtained analytical relations of stress, lateral stretch, director orientation, and coupled shear deformation as a function of the applied stretch are plotted in FIG. 5 parts B-E, respectively. In Stage I, LCE behaves in a standard uniaxial fashion with no director rotation and shear. When the applied stretch enters Stage II, stiffness drops significantly, and stretch in out-of-plane direction (λ_{zz}) freezes while vertical stretch (λ_{yy}) accelerates its descent. Meanwhile, the director starts to rotate and asymptotically converges to π/2 when stretch approaches infinity, and coupled shear also occurs with a speed initially fast and subsequently decaying. Macroscopically, the shear deformation appears in a zig-zag and alternating fashion in the vertical direction, forming a stripe pattern. The model without the frozen director condition (Equation 2) suits LCE fabricated in the isotropic phase, predicts a three-stage, stiff-soft-stiff stress-stretch response.

In these embodiments, the values of the LCE parameters are chosen as Q₀=0.5, μ=0.0829, and ω=0.0401. The Q₀ value is a typical value for the nematic-phase LCE. The value of u is chosen to match the 0.04 MPa initial slope of the stress-strain curve obtained in the direction perpendicular to the director of a nematic-genesis LCE. The value of ω is chosen to match the 0.027 MPa critical stress (corresponding to the kink of the stress-strain curve).

### 3. Temperature-Induced, Stress-Free Spontaneous Deformation

The stress-free, spontaneous deformation along the no can be obtained by taking the stationary condition of Equation 4, which leads to

$${λ}_{spon} ( Q ) = {[ \frac{( 1 - {Q}_{0} ) ( 1 + 2 Q )}{( 1 - Q ) ( 1 - 2 {Q}_{0} )} ]}^{1 / 3} \qquad ( 5 )$$

This expression is the same with or without the frozen-director condition as the stress-free contraction or extension aligns with n₀ and preserves n=n₀. Also λₛₚₒₙ depends solely and nonlinearly on Q₀ and Q. Based Equation 5, a nematic-isotropic transition (Q₀=0.5 and Q=0) produces a spontaneous contraction (stretch) of 0.63, and an isotropic-nematic transition produces a spontaneous extension of 1.6. The magnitude of both values agrees with experimental observations. The order parameters Q₀ and Q depend on the initial and current temperatures, i.e., T₀ and T respectively. The Q−T relation is in general nonlinear and monotonically decreasing with Q reaching 0 (isotropic state) at the transitional temperature T_{cr}. While the shape of the Q−T curve is similar for different nematic LCEs, the value of T_{cr} depends heavily on the LCE material composition and fabrication process. The T_{cr} of different LCEs can vary from 20° C. to over 120° C. As this work is not restricted to a specific type of LCE and requires no direct temperature information for numerical simulation a specific Q−T relation is not assumed but instead the LCE composite is directly loaded through Q in FEA. If the application scenario requires a Q−T relation, one can adopt established models such as the power law.

### 4. Plane Stress Condition

As some embodiments herein focus on 2D LCE composite structures with in-plane no and identical material distribution in the thickness direction, it is assumed that the plane stress condition and absence of out-of-plane warping. Computation-wise, the plane stress condition enables standard displacement-based 2D FEA with incompressible materials. With the X and Y axes lying in the plane, the plane stress condition requires F₁₃=F₂₃=F₃₁=F₃₂=0, and other components are, in general, zero. In the context of LCE, such F implies that any stripe pattern would take place in-plane rather than through the thickness direction. With this form of F and n_{0,3}=0 (no in-plane), by substitution, the 2D plane-stress version of W in Equation 4 is obtained in terms of the 2D deformation gradient F and 2D director no as

$$W ( \overline{F} ) = \frac{μ}{2} [ \frac{1 - {Q}_{0}}{1 - Q} ( Tr ( \overline{C} ) + \frac{1}{{\overline{J}}^{2}} ) + ( \frac{3 {Q}_{0}}{1 + 2 Q} - ω ) {\overline{n}}_{0} \cdot \overline{C} {\overline{n}}_{0} - ( \frac{3 Q ( 1 - {Q}_{0} )}{( 1 - Q ) ( 1 + 2 Q )} - ω ) \frac{{\overline{n}}_{0} \cdot {\overline{C}}^{2} {\overline{n}}_{0}}{{\overline{n}}_{0} \cdot \overline{C} {\overline{n}}_{0}} - 3 ] \qquad ( 6 )$$

Where C̅:=F̅^{T}F̅ and J̅:=det(F̅). The form of the 2D energy in Equation 6 is similar to the 3D version in Equation 4, except for the appearance of J̅ in the 2D version. This term is from Tr(C) term in Equation 4 and implies planar stretchability although the material is incompressible. The 2D model Equation 6 is used for finite element implementation. In some cases, a small number (e.g., 3) may be subtracted within the brackets to make Equation 6 more rigorous.

In addition to LCE, isotropic hyperelastic materials inactive to temperature are included as candidate materials for optimization. The material is referred to as the passive material throughout these embodiments. Its behavior is described by the neo-Hookean model, with the 2D plane-stress stored energy density function

$${W}_{P} ( \overline{F} ) = \frac{{μ}_{P}}{2} ( Tr ( \overline{C} ) + \frac{1}{{\overline{J}}^{2}} - 3 )$$

Where μ_{P} is the shear modulus of the passive material.

For applications involving three-dimensional stress states and deformations, such as 3D LCE structures and 2D LCE sheets with out-of-plane bending, the general 3D model Equation 4 or Equation 2 should be adopted. This would, however, lead to increased computational cost caused by not only the curse of dimensionality but also solving for the Lagrange multipliers associated with incompressibility and, for the free-director case Equation 2, inextensibility of n.

### C. Optimization Formulation for Programming Arbitrary Deformed Shape of LCE

### 1. Multimaterial Characterization of LCE Composites

The embodiments herein aim to optimize the geometry of LCE material and its director distribution to achieve prescribed deformed shapes or maximized actuation upon temperature change. This involves a systematic design characterization of LCE composites consisting of LCEs with different candidate directors and a passive, isotropic elastomer. A multimaterial characterization approach is to represent multiple anisotropic materials, such as fiber-reinforced elastomers and soft materials with magnetization directions.

The geometry of the LCE composite is characterized by a density design variable ρ with ρₑ associated with element e. The value of ρₑ=1 indicates that the domain of element e is solid, and ρₑ=0 means that the domain is void (no material). To achieve mesh independence, minimal size regularization, and near-discreteness of the design variables, the standard filter technique and Heaviside projection are used to obtain the physical variable ρₑ, which is used to represent the physical geometry of the LCE composites.

LCE with different directors n₀ and passive material are characterized as different material phases for the optimization, which allows the use of established multimaterial characterization frameworks. The embodiments herein adopt the Hypercube-to-Simplex Projection (HSP) approach, which can be used in multimaterial topology optimization. The HSP approach relates a set of material design variables ξ with the physical material variable m used to represent the material phase distribution of the LCE composite. Assuming a total of M+1 material phases (M phases of LCE with different directors plus a passive material), the physical variable is m is a N×(M+1) matrix with mₑ^{(j)} denoting the (e, j) component and representing the proportion of material phase j in element e; and the material design variable ξ is a N×M matrix. Based on the HSP, the relation mapping of ξ to m is

$${\overline{m}}_{e}^{( j )} = {\sum }_{i = 1}^{{2}^{M}} {s}_{i}^{( j )} ( {( - 1 )}^{( M + {\sum }_{k = 1}^{M} {c}_{i}^{( k )}} {\prod }_{l = 1}^{M} ( {\overline{ξ}}_{e}^{( l )} + {c}_{i}^{( l )} - 1 ) ) \qquad ( 7 )$$

$$Where j = 1 , … , M and {\overline{m}}_{e}^{( M + 1 )} := 1 - {\sum }_{j = 1}^{M} {\overline{m}}_{e}^{( j )} , where {c}_{i}^{( j )}$$

is the ith vertex of an M-dimensional unit hypercube for the jth material phase, and

$${s}_{i}^{( j )}$$

is the mapped vertex of a M-dimensional standard simplex domain

$${s}_{i}^{( j )} = \{ \begin{matrix}\frac{{c}_{i}^{( j )}}{{\sum }_{q = 1}^{M} {c}_{i}^{( q )}} & if {\sum }_{q = 1}^{M} {c}_{i}^{( q )} \geq 1 \\ 0 & otherwise\end{matrix} \qquad ( 8 )$$

$$And {\overline{ξ}}_{e}^{( l )}$$

is the projected material variable obtained through the same

filtering and projection procedure as ρₑ. Notably,

$${\overline{m}}_{e}^{( j )} \geq 0 , j = 1 , … , M and {\sum }_{j = 1}^{M} {\overline{m}}_{e}^{( j )} \leq 1 .$$

The two physical variables ρ̅ and m̅ can fully represent the geometry and material distribution of any composites with M LCE directors and a passive material phase up to the finite element resolution.

### 2. Interpolation of Stored-Energy Density Function

Continuous optimization involves interpolation of material properties (i.e., stored energy density functions) based on the physical variables. Based on the HSP approach, the fictitious mixed material's energy inside element e is interpolated through the physical variables as

$${W}_{e} ( \overline{F} ; {\overline{ρ}}_{e} , {\overline{m}}_{e} , {γ}_{e} ) := [ ϵ + ( 1 - ϵ ) {\overline{ρ}}_{e}^{p} ] {\sum }_{j = 1}^{M + 1} {( {\overline{m}}_{e}^{( j )} )}^{{p}_{ξ}} {\tilde{W}}^{( j )} ( \overline{F} ; {γ}_{e} ) \qquad ( 9 )$$

Where ∈=10⁻⁶ is a small number to prevent singularity, p and p^{ξ} are penalization parameters, and γₑ∈[0,1] is a near-discrete dependent variable of Pe serving as the characteristic field such that γₑ=1 in solid regions and γₑ=0 in void regions. \tilde{W}(F; γₑ) is given as

$${\tilde{W}}^{( j )} ( \overline{F} , {γ}_{e} ) := {W}^{( j )} ( {γ}_{e} \overline{F} ) - {W}_{PL} ( {γ}_{e} \overline{F} ) + {W}_{PL} ( \overline{F} ) \qquad ( 10 )$$

Where, if j≤M−1, W^{(j)}(F̅) is the (plane stress) LCE energy density given in Equation 6 with j denoting the jth candidate director

$${n}_{0}^{( j )} ,$$

and if j=M, W^{(M)}(F̅) is the neo-Hookean energy density representing the passive material. Also,

$${W}_{PL} ( \overline{F} ) := \frac{1}{2} \overline{ε} ( \overline{F} ) : \overline{{ℂ}_{0}} : \overline{ε} ( \overline{F} )$$

is the linearized plane-stress stored-energy function for the void regions used to prevent numerical instability, and C₀ is the plane-stress isotropic incompressible elastic tensor for the passive void-region fictitious material defined by the corresponding shear modulus μ₀. Here, μ₀=min{μ, μ_{P}}.

The introduction of γ and W_{PL} is for preventing numerical instability in void regions, which is a common numerical issue in large-deformation topology optimization if no special treatments are applied. In solid regions (ρ̅ₑ=1 and γₑ=1), the interpolated energy of Equation 9 recovers the LCE model of Equation 6 (if j≤M) or the passive material model W_{P} (if j=M+1), and both are physically well-defined. In void regions (ρₑ=0 and γₑ=0), the stored energy of Equation 9 becomes ∈W_{LP}(F̅), which is orders of magnitudes smaller than the energy in the solid region such that its influence on the global behavior of solid regions is negligible.

### 3. Nonlinear FEA for LCE Composites

The finite element method (FEM) can be used to solve the elastostatics problem of LCE under temperature change realized by Q≠Q₀. A displacement-based 2D FEM is adopted with the total Lagrangian formulation and quadrilateral bilinear element with four Gauss points. In the FE discretized domain, the global displacement vector at the equilibrium u of the LCE composite defined by ρ and ξ is obtained by minimizing the total potential energy Π(ρ, ξ, ν) with respect to the global FE displacement vector ν, i.e.,

$$u ( ρ , ξ ) = arg {min}_{v ∈ K} \prod ( ρ , ξ , v ) := {\sum }_{e} {\int }_{{Ω}_{0} , e} {W}_{e} ( \overline{F} ( {v}_{e} ) ; {\overline{ρ}}_{e} ( ρ ) , {\overline{m}}_{e} ( ξ ) , {γ}_{e} ( ρ ) ) d Ω \qquad ( 11 )$$

Where K is the kinematically admissible set, Ω₀, e is the domain of element e in the reference configuration, νₑ is the 2D element displacement vector, and Wₑ is given in Equation 9. The stationary condition is such that

$$r ( ρ , ξ , v ) = \frac{\partial \prod ( ρ , ξ , v )}{\partial v} = 0 \qquad ( 12 )$$

The nonlinear Equation 12 can be solved by the Newton-Raphson method where the tangential stiffness matrix at displacement ν is

$$K ( ρ , ξ , ν ) = \frac{{\partial }^{2} Π ( ρ , ξ , ν )}{\partial {ν}^{2}} .$$

Herein, displacement vectors are one way of representing the deformation capabilities of substances.

### 4. Optimization Formulation

This subsection provides an optimization formulation with a general objective function for the inverse optimization of LCE composites. In the following, the specific form of the objective function will be introduced and elaborated on, which is the proposed curvature-based description. The inverse optimization problem can be stated as: vary the density and material design variables (and potentially additional design variables) to minimize an objective function subject to certain constraints. Formally, it is stated as

$${min}_{ρ , ξ , z} J ( ρ , ξ , z , u ( ρ , ξ ) ) + α V ( ρ ) + {α}_{LCE} {V}_{LCE} ( ρ , ξ ) \qquad ( 13 )$$

$$such that$$

$$V ( ρ ) - {V}_{0} \leq 0$$

$$and$$

$${ρ}_{e} , {ξ}_{e}^{( j )} ∈ [ 0 , 1 ] , e = 1 , … , n ; j = 1 , … , M$$

With u(ρ, ξ) such that r(ρ, ξ, u)=0, wherein J is the part of the objective function used to describe the targeted performance of the LCE composite (such as the error between the actual and target deformed shapes), and its specific form will be given in the following subsections, z stands for additional and optional design variables. Two volume penalization terms are included in the objective function to (mildly) penalize the total volume V and total LCE volume V_{LCE} for removing possible superfluous materials in the final design. The total volume is also set as a constraint that specifies the maximum allowable total volume fraction V₀ in the design. The constraint can be seen as removed if V₀≥1. Finally, the (discretized) nonlinear state equation is satisfied by requiring the residual r=0.

Put another way, ρ represents geometry, e.g., whether a passive material or an LCE is used at locations within the shape, while ξ is an N×M matrix representing the material design, e.g., the orientation of the LCE material if it is present at that point in the matrix. Further, u(ρ, ξ) represents the global displacement vector at equilibrium u of the LCE component defined by ρ and ξ. It is obtained by minimizing the total potential energy with respect to the global finite element displacement vector. The terms α and α_{LCE} are weights that penalize higher volumes for the passive material and the LCE material, respectively.

The sensitivity of the objective and constraint functions with respect to the design variables are obtained with the adjoint method through

$${\frac{\partial ϕ}{\partial {y}_{e}} = \frac{\partial ϕ ( ρ , ξ , \overline{u} )}{\partial {y}_{e}} \vert}_{\overline{u}} + {λ}^{T} \frac{\partial r ( ρ , ξ , \overline{u} )}{\partial {y}_{e}} \qquad ( 14 )$$

Where ϕ is either the objective or constraint function, yₑ is either ρₑ or ξₑ, and λ is the adjoint vector attained by solving the adjoint system

$${K}^{T} ( ρ , ξ , \overline{u} ) λ = \frac{\partial ϕ ( ρ , ξ , \overline{u} )}{\partial \overline{u}} \qquad ( 15 )$$

The sensitivity is input to the gradient-based method of moving asymptotes (MMA) to update the design iteratively.

### 5. Curvature-Based Formulation for Programming the Deformed Shapes of LCE Composites

The inverse optimization involves defining a variable capable of robustly and accurately characterizing the deformed shape of LCE composites, and this is challenging for three reasons. First, the variable should accurately represent the inherent properties of the geometry and be independent of overall orientation or observer change. Second, the variable should be unrelated or insensitive to overall scaling so that a shape with different sizes should be characterized as the same kind. Third, the variable should be based on the current deformed configuration which, in general, differs significantly from the undeformed configuration in shape, area, and length. These requirements lower the applicability of straightforward location-based formulation that assigns target locations to a collection of material control points, as such a formulation is defined with respect to an overall orientation and absolute size, hence being too restrictive for optimization. Also, any intuitively determined target locations are unlikely to be those that are most easily achievable by the LCE composites, hence deteriorating the accuracy of the programmed shape.

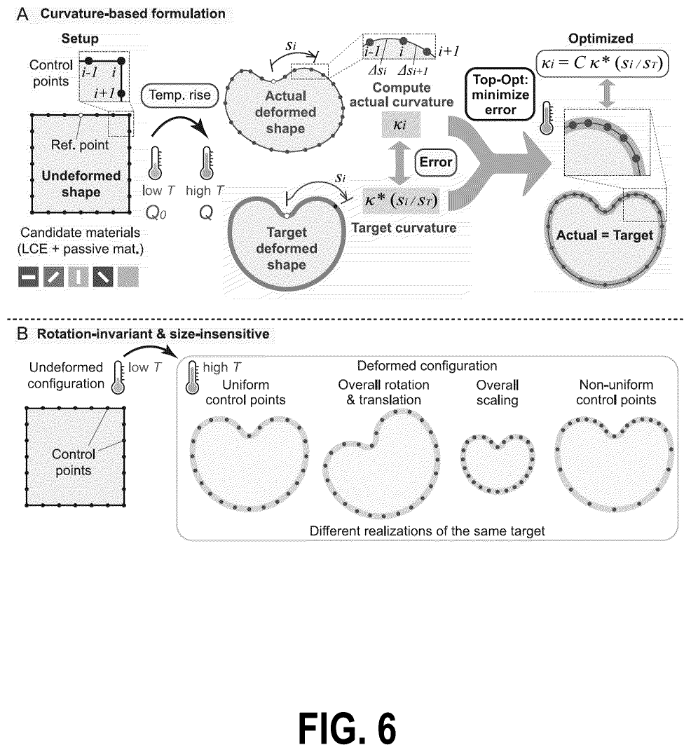

To address the above challenges, a curvature-based characterization for programming the deformed shape of LCE composites is proposed as illustrated in FIG. 6 part A. This can involve programming the curvature of a curve describing the current deformed configuration of the composite to match prescribed target values. As illustrated in the optimization setup of FIG. 6 part A, the formulation can be built upon a collection of material control points that form a discretized curve. Upon temperature rise, the LCE composite and the curve deform to their current configurations. Then, the (discretized) curvature of the current curve κ is programmed to match the specified target curvature (κ*) through topology optimization. When the error between the actual and target curvatures is minimized, the actual deformed shape will match the target. Accordingly, the objective function to be minimized is defined as the error between the actual and target curvatures, i.e.,

$$J ( ρ , ξ , C , u ( ρ , ξ ) ) = \frac{1}{2 N} {\sum }_{i = 1}^{N} {[ {κ}_{i} ( u ( ρ , ξ ) ) - C {κ}^{*} ( \frac{{s}_{i} ( u ( ρ , ξ ) )}{{s}_{T} ( u ( ρ , ξ ) )} ) ]}^{2} \qquad ( 16 )$$

Where N is the total number of material control points, κᵢ is the (discretized) curvature of the ith control point, κ* is the prescribed target curvature function that depends on the normalized arc length of the control point, with sᵢ being the arc length of the ith control point measure from a reference control point and s_{T} the total arc length, and scalar C is a dummy design variable for removing size dependence.

The objective function can be supplied to an iterative optimization solver application to determine locations and orientations of the LCE material within a non-deformed state of the substance (e.g., prior to applying temperature such that the substance transforms from the non-deformed substance into a target deformed shape). In some cases, a finite element mesh representation of the substance may be constructed, at least in part, between iterations of the optimization, and the parameters of subsequent iterations of the optimization may be selected in part based on a gradient determined between the current iteration and one or more previous iterations. Once solved and the values for ρ, ξ, and optionally z are determined, these values and other underlying characteristics of the substance can be provided as a digital model to a manufacturing system. The manufacturing system may responsively produce the substance in its non-deformed state.

As illustrated in FIG. 6 part B, the proposed curvature formulation is independent of overall rotations and translations of the deformed configuration. The formulation is also insensitive to overall scaling due to the introduction of the dummy design variable C as the optimizer can choose any (positive) C value to scale the target curvature for achieving a better fit. Finally, the formulation is insensitive to the distribution of the control points in the current configuration, as the target curvature κ* is formulated as a function that depends on the control point's relative location sᵢ/s_{T} along the curve. For a control point, a change of location (e.g., at different optimization steps) indicates a change of its κ* value, which is determined based on the spatial description of the target shape. Conceptually, such treatment of κ* implies two mechanisms for the optimizer to improve fitting. The first is to change κᵢ without changing the location sᵢ/s_{T} and κ*, and the second is to change κ* through changing the location sᵢ/s_{T} but without altering κᵢ. The second mechanism automatically deactivates when the target curvature is constant (e.g., a circular or linear segment). Note that κ* should not be formulated as pre-determined and fixed values for the control points as the target value depends on the current locations that are generally unknown before solving the state equations. As illustrated in FIG. 6 part B, the formulation can effectively consider the three different types (and their combinations) of realizations of the same target shape, and hence, it enjoys a large optimization search space unavailable for location-based and size-sensitive formulations.

For the computation of κᵢ in Equation 16, the continuous formula is κ(s)=x′(s)y″(s)−y′(s)x″(s). where s is the current arc length, and x and y are the current planar locations at s with the prime denoting derivatives with respect to s. Based on this formula, the embodiments herein use a three-point finite difference scheme to compute the discretized curvature κᵢ, i.e.,

$${κ}_{i} = \frac{{x}_{i + 1} - {x}_{i - 1}}{Δ {s}_{i} + Δ {s}_{i + 1}} \frac{4 ( {y}_{i + 1} - 2 {y}_{i} + {y}_{i - 1} )}{{( Δ {s}_{i} + Δ {s}_{i + 1} )}^{2}} - \frac{{y}_{i + 1} - {y}_{i - 1}}{Δ {s}_{i} + Δ {s}_{i + 1}} \frac{4 ( {x}_{i + 1} - 2 {x}_{i} + {x}_{i - 1} )}{{( Δ {s}_{i} + Δ {s}_{i + 1} )}^{2}} \qquad ( 17 )$$

Where Δsᵢ:=sᵢ−sᵢ₋₁ as indicated in the top middle box of FIG. 6 part A. Notably, the distance of control points in the current configuration is generally non-uniform even if they are uniform in the undeformed configuration. Hence, the standard three-point central difference in Equation 17 is not as second-order accurate as it is in the equidistant case. However, numerical investigations show satisfactory fitting of the target shape.

### D. Results

This section demonstrates the effectiveness of the proposed framework and curvature formulation in achieving various target shapes with different complexities. In addition to programming LCE's deformed shape, maximizing the actuation displacement of LCE composites are investigated, as LCE is frequently used as actuators.

For the curvature programming, the focus is on optimizing the material distribution through ξ rather than the structural topology represented by ρ, and the latter is frozen to 1. To avoid bad local optima, a continuation scheme is adopted for the penalization parameter p_{ξ} and Heaviside parameter β_{ξ}, both are initially set to 1. At the 100th step, p_{ξ} starts to increase by 0.5 every 20 steps until reaching 3 at the 180th step, where β_{ξ} starts to increase with the same pattern and reaches 64 at the 300th step. The maximum number of steps is set to 330. Although the Heaviside projection is employed, small regions with mildly mixed materials can still appear in some design cases. To ensure the complete discreteness of the final design, a discrete projection is applied as post-processing to the optimized results. The responses presented herein are those of the discrete designs.

1. Strip Morphing into Complex Shapes

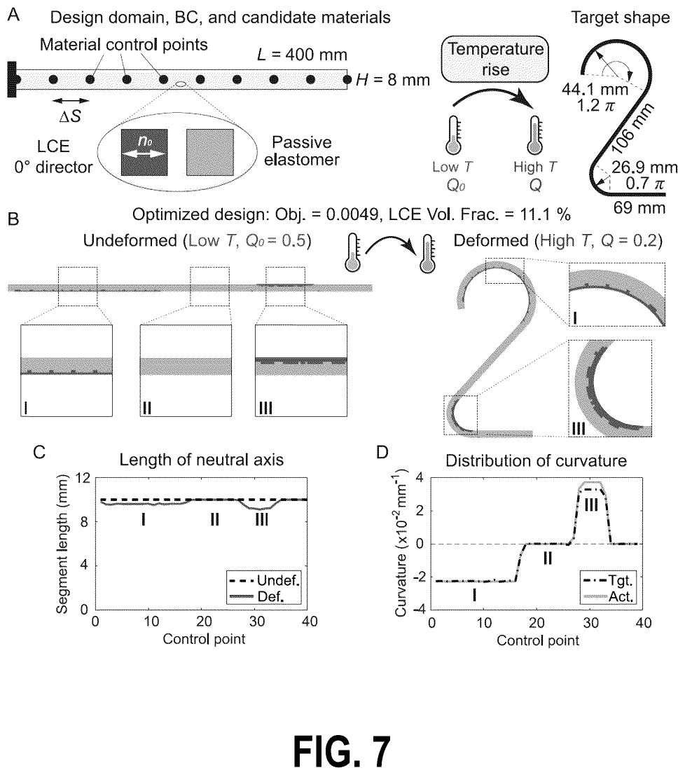

In this subsection, a goal is to program the deformed shape of a slender and solid (no voids) LCE composite strip as indicated in FIG. 7 part A. The strip domain has a size of L×H=400 mm×8 mm (with 1 mm thickness) and is fixed on the left edge. The FE mesh for the domain is 400×8. Two material phases (M=1) are considered: LCE with no along the longitudinal direction and a passive neo-Hookean elastomer. This is because the strip deforms mainly in bending which can be actuated by LCE contraction on the top or bottom layer of the strip. As will be shown in the results, considering only one LCE director candidate is sufficient for the accurate realization of various shapes. Also, as will be demonstrated later that the strip structure deforms mainly in bending and shows little axial deformation because of its slender geometry, unchanged arc lengths are assumed for before and after the deformation, but only for this example. The constant arc length assumption simplifies the computation of the current curvature expression from Equation 17 to

$${κ}_{i} = ( \frac{{x}_{i + 1} - {x}_{i - 1}}{2 Δ s} ) ( \frac{4 ( {y}_{i + 1} - 2 {y}_{i} + {y}_{i - 1} )}{{( Δ s )}^{2}} ) - ( \frac{{y}_{i + 1} - {y}_{i - 1}}{2 Δ s} ) ( \frac{4 ( {x}_{i + 1} - 2 {x}_{i} + {x}_{i - 1} )}{{( Δ s )}^{2}} )$$

Where ΔS is the (equidistant) segment length between the material control points as indicated in FIG. 7 part A. The simplification also allows for prescribing a fixed target curvature value to each material point, i.e., the κ* in Equation 16 reduces to a scalar constant from a function. The constant arc length assumption is not applied to examples in the following two examples.

For solid LCE composite strips, only the material variable ξ is optimized, and the density variable ρ=1 is excluded from the optimization. In experiments, a total of N=39 control points that equally divide the neutral axis into 40 segments as illustrated in FIG. 7 part A. Other parameters are set as follows: α_{LCE}=0.05, V_{LCE,0}=1, and the filter radius is 3 mm. With this setup, the strips are programmed into target shapes of numbers 2, 3, 6, and 7, which have varying curvatures along their arc lengths. These target shapes are represented by tangentially joined circular and linear segments with total arc lengths equal to the length of the domain, i.e., 400 mm. Hence, for any region of a target shape, the target curvature is either a constant or zero. The computer configuration is CPU: AMD Ryzen Threadripper 3970X 32-Core Processor 3.69 GHz and RAM: 256 GB. For this family of examples, the average computational time for the entire optimization process (with maximum 330 optimization steps) is approximately 45 minutes.

A first focus is on the target shape of number 2 as indicated in FIG. 7 part A and Q=0.2 is used (before reaching the isotropic state). The target shape comprises two circular arcs and two line segments joining tangentially. Starting from the top left of the number 2, the first arc has a radius of 44.1 mm and an angle of 1.2π, and the first line segment has a length of 106 mm, then the second arc has a radius of 26.9 mm and an angle of 0.7π, and finally, the second line segment has a length of 69 mm. The corresponding optimized designs (undeformed and deformed) are shown in FIG. 7 part B, with dark sections indicating the LCE and lighter sections indicating the passive elastomer. For illustration, the deformed shape is rotated to align with the normal orientation of the number 2, which will not alter the curvature and hence the objective function. The deformed configuration shows the accurate realization of the shape of the number 2. As expected, the distribution of LCE concentrates on the sides of the strip to effectively generate curvature through the temperature-induced axial contraction as demonstrated in FIG. 7 part B. The volume of LCE is about 11.1% of the strip, indicating that complex shapes can be realized with a relatively small amount of LCE. As a check for the constant arc length assumption, FIG. 7 part C shows the actual deformed arc length segments among the control points versus the undeformed values. The deformed arc length remains largely unchanged from the initial ones, which justifies the constant arc length assumption. Some mild changes are seen in Parts I and III of the strip where LCE appear.

FIG. 7 part D shows the distribution of the actual and target curvature along the neutral axis, which verifies the overall accurate fitting. Small discrepancies appear in Part III due to post-processing that removes some mildly mixed materials (LCE and passive material) on the convex side of the deformed strip, leading to the locally magnified curvature.

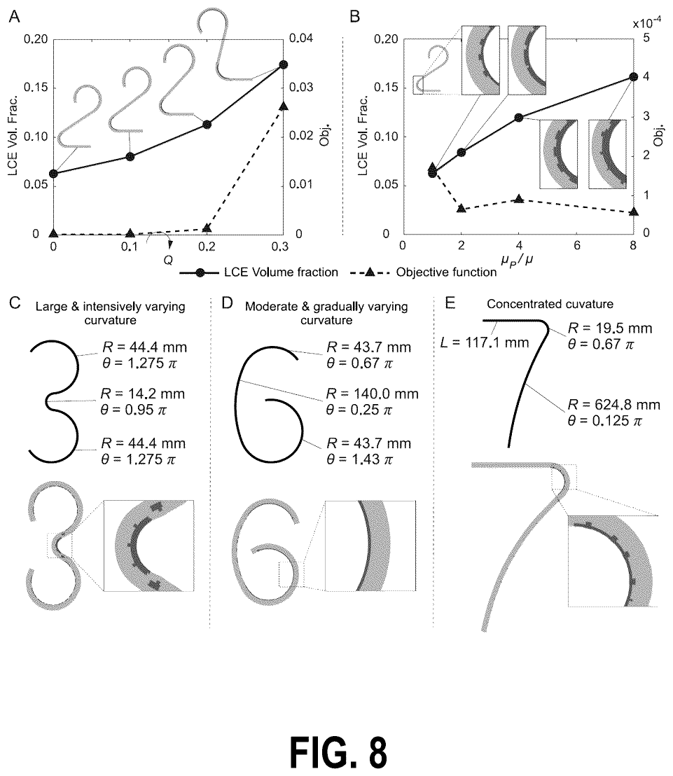

Using the inverse optimization framework, the same target shapes can be achieved under a wide range of temperatures (Q values). This is demonstrated in FIG. 8 part A, where the results are obtained with Q=0, 0.1, 0.2, and 0.3, respectively. As shown in the deformed configurations, the results with Q=0, 0.1, and 0.2 achieve the target shape of 2 fairly accurately, but Q=0.3 produces a poor fit due to insufficient actuation. This trend is quantitatively shown in the objective function value-Q plots in FIG. 8 part A. Also, larger Q (lower current temperatures) generally requires more LCE to generate the target curvatures as shown in the nonlinear Q-LCE volume fraction curve in FIG. 8 part A.

Change in the passive material stiffness alters the final LCE volume while retaining accurate fits as demonstrated in FIG. 8 part B, which shows the objective function value—μ_{P}/μ and LCE volume fraction—μ_{P}/μ relations with the stiffness ratio (between passive and LCE materials) μ_{P}/μ=1, 2, 4, and 8, respectively. The rise of the stiffness ratio μ_{P}/μ generally requires more LCE to achieve an accurate fit. The volume increase is clearly visible in the zoomed-in views of the deformed configurations where the thickness of the LCE layer increases as the stiffness ratio rises.

Using the framework and assuming a nematic-isotropic transition (Q=0), these embodiments realize various other target shapes of numbers 3, 6, and 7 as demonstrated in FIG. 8 parts C, D, and E. The corresponding targets are defined by tangentially joining circular arcs and line segments with the radius R, angle θ, and linear length L of each part of the targets given in FIG. 8 parts C, D, and E. All strips show accurate realizations of the target shapes that have drastically different distributions and magnitudes of curvatures along their contour. As expected, the distribution of LCE concentrates in regions with large curvatures, such as the middle region of number 3 and the sharp corner of number 7. By contrast, number 6 features a gradually varying curvature and hence results in a relatively uniform distribution of LCE.

### 2. Programming the Planar Deformed Shape of LCE Composite Sheet

This subsection focuses on programming the planar deformed shape of 2D sheets made of LCE composites upon temperature rise. Planar spontaneous deformation of LCE can be harnessed for biomedical applications and planar actuations. The inverse optimization of LCE distributions for 2D sheets to achieve complex target shapes remains a main challenge. Through several numerical examples, it is demonstrated that shapes with wide-ranging complexity can be accurately achieved by rectangular-domain LCE composite sheets.

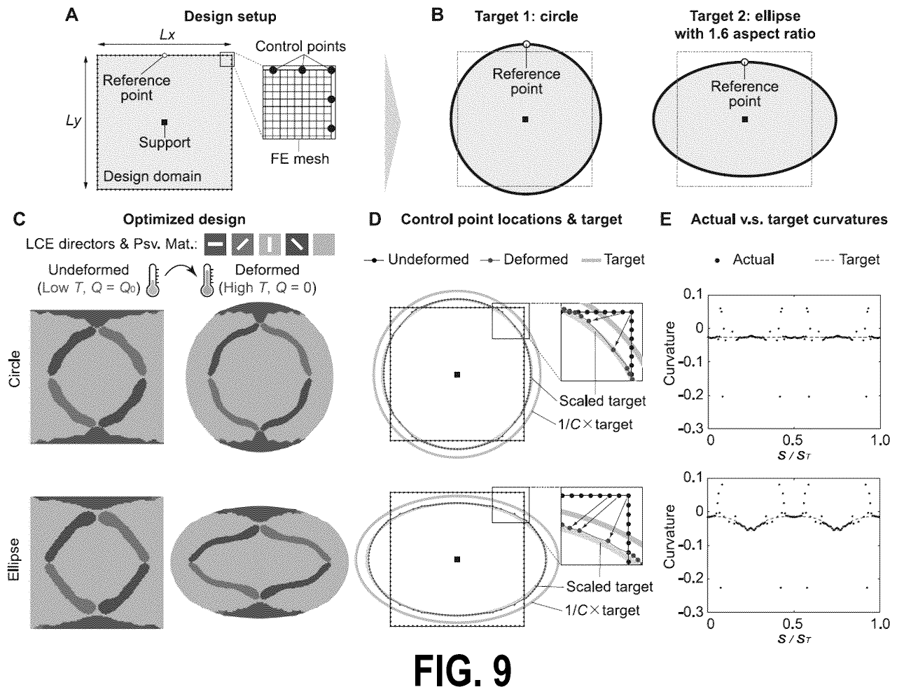

To represent the 2D shape, the control points are uniformly distributed along the perimeter of the undeformed configuration as illustrated in FIG. 9 part A. Unlike the slender strip structure, the deformation of the 2D sheet can significantly change the local lengths of the perimeter, and hence, the constant arc length assumption does not apply and the general curvature-based formulation of Equation 16 (excluding p) can be used.

To maximize the temperature-induced shape-changing capacity, an extremely soft elastomer with μ_{P}=0.001 MPa as the passive material is used. Such soft passive elastomers have been produced and can be 3D-printed. For the LCE, four candidate directors (M=4) are included with angles being 0, π/4, π/2, and 3π/4. A nematic-isotropic transition (Q=0) is used to generate maximal actuation.

Initial steps involve programming a square sheet of LCE composite to deform into a circle and an ellipse with a 1.6 aspect ratio as illustrated in FIG. 9 parts A and B. For the circle, κ*=−1/R₀ is a constant function where R₀ is the radius. For the ellipse, κ* can be obtained by the ellipse equation. The control points and the FE mesh (120×120 elements) are shown in FIG. 9 part A, where a total of 120 control points are used. Other optimization parameters are as follows (for both cases): α_{LCE} is 0.1, and the filter radius is 6. The average computational time of the entire optimization process for this set of examples is approximately 1 h and 30 min.

The optimized designs are shown in FIG. 9 part C, and their undeformed and current locations of control points are plotted on top of the target shapes scaled by the optimized C value as shown in FIG. 9 part D. The deformed shapes demonstrate the accurate realization of the circle and ellipse. Both structures possess relatively irregular distributions of LCE while producing a smooth boundary in the deformed configurations even though the undeformed shape has four sharp corners. The optimized distribution reveals the mechanism for achieving the target shape. The four sides are occupied by LCEs with directors parallel to the side (the blue and yellow parts) to generate contraction while the four internal members with π/4 and 3π/4 directors adjust the internal displacement fields. These features are present for both the circle and the ellipse. The ellipse has an extra vertical member at the center with π/2 director (yellow), which generates vertical contraction and squeezes the sheet into an ellipse. Therefore, although seemingly irregular, the LCE distributions reveal different roles for each of the LCE members. These optimized distributions and sizes are generally difficult to attain by intuition.

As demonstrated in FIG. 9 part D, the distance among the control points of the current configuration varies significantly along the perimeter, which necessitates the use of current arc lengths to accurately compute curvature. Such large curvature variation is absent in the strip structure. FIG. 9 part E shows the distribution of the control point's curvatures along the perimeter with their targets scaled by the optimized C (which gives the actual target), demonstrating accurate fitting. A few data points associated with control points near the corners show large shifts from the target, but the impact of such shifts on the overall fitting seems negligible as it is local.

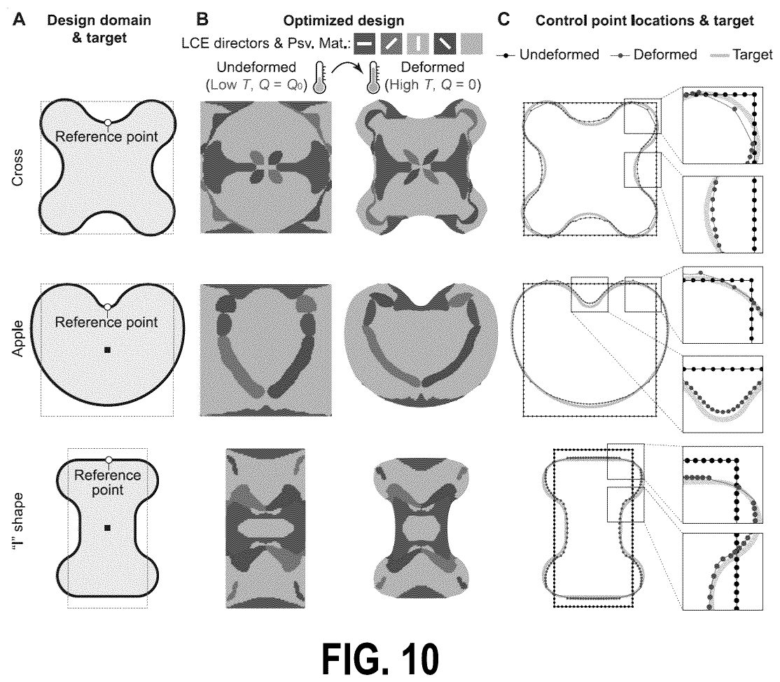

Using the general formulation of Equation 16, target shapes with more complex geometries are investigated, including the shape of a cross, an apple, and the letter “I”, as shown in FIG. 10 part A. For the cross and apple targets, the domain, mesh size, supports, and filter radius are the same as those for the circle and ellipse. For the “I” shape, a rectangular domain was used with B=60 and H=120, a mesh size 60×120, and a filter radius of 6.5. The curves of the cross and apple shapes are defined by tangentially joining circular segments with different angles and radii, and the “I” shape additionally includes lines. Note that, unlike the ellipse, these target shapes are non-convex with varying curvatures along the perimeters. Accurate realization of these shapes is highly challenging and beyond the capacity of intuition. The average computational cost of the entire inverse optimization process for apple- and cross-shaped targets is approximately 2 h, and that for the I-shaped target is approximately 1 h.

The optimized designs for the three target shapes are shown in FIG. 10 part B, and their undeformed and current control point locations are plotted on top of the scaled targets in FIG. 10 part C. All three optimized LCE composites accurately achieve their targets. For the cross, the blue and yellow members in the middle pull in the center parts of the four sides while the small members near the corners squeeze out the four corners. In general, the optimized geometry of the LCE members is highly irregular and their size varies among different parts. The magnitude and nonlinearity of the members are high as shown in the severely distorted members near the corners. Also, as shown in FIG. 10 part C, the distance among the originally uniform control points varies significantly in the deformed configuration. Those at the corners were severely stretched while those at the other parts of the boundary are compressed due to LCE contraction. Although severely stretched and compressed, the perimeter of the deformed shape is smooth.

The apple-shaped target is symmetric about the Y-axis only and exhibits large variations of curvature, with the curvatures at the cusp much larger than those at the bottom. As shown in FIG. 10 part B, the optimized LCE composites accurately achieve the target. The four corners in the undeformed configuration are smoothed. The accurate realization of the apple shape is enabled by the optimized distribution, geometry, and sizes of the LCE members. The yellow vertical member vertically squeezes the structure. The dark members at the top contract, and, together with the down-pulling of the vertical member, generate the large inward warping representing the cusp. LCE also occupies the other three sides with parallel directors to generate the curved outline. The magnitude of strain and rotation is revealed by the deformed shape and orientation of those small members at the top half.

The I-shaped target has a more sophisticated curvature variation with zero values at the straight parts of the boundary and values with reversed signs at the curved segments. As shown in FIG. 10 part B, the deformed shape accurately achieves the target. Unlike the previous two designs, the LCE members here are intricately connected and show more complex geometries that seem to form certain mechanisms. The triangular dark LCE members at the top and bottom produce straight segments, and the dark parts in the middle contract horizontally to thin and expand vertically to elongate the middle parts of the “I” shape. The other members horizontally expand the top and bottom parts of the “I” shape. Highly irregular and intricately connected, the optimized members jointly produce the target shape difficult to achieve by experience.

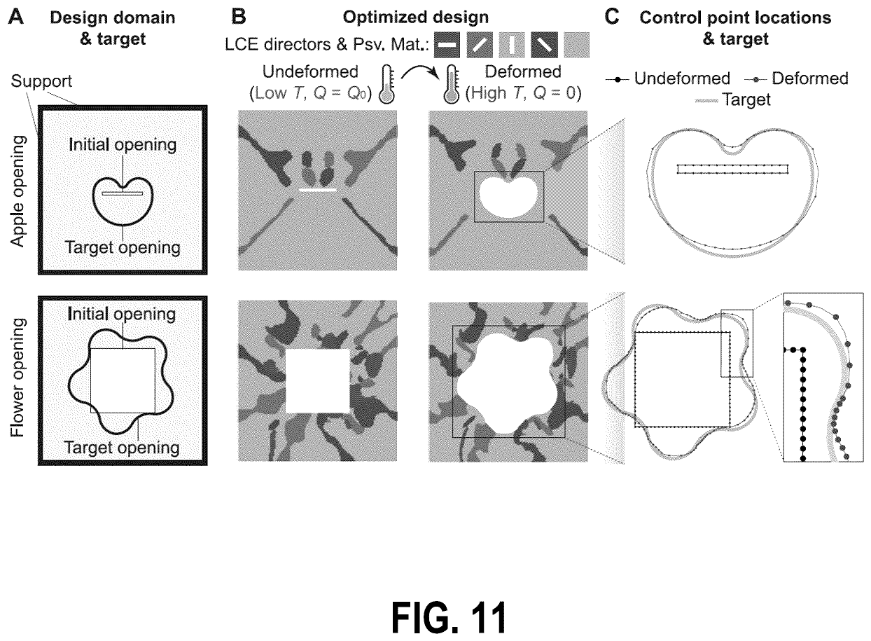

Besides programming the deformed shape of a solid sheet, accurate control of the shape of openings is also valuable for applications such as smart wound closure and thermal management metamaterials. Here, the proposed formulation is used to inversely optimize the deformed shape of openings in a sheet. Two setups are considered as illustrated in FIG. 11 part A. Setup 1 has a thin gap in the middle of the sheet with a target shape of an apple, and Setup 2 has a square opening with a diagonally symmetric flower-shaped target. For both setups, the control points are evenly distributed along the perimeter of the opening. Both domains are fixed at the exterior boundaries and have a size of 120 mm×120 mm. The domain is discretized in both directions by 120 finite elements. The filter radius is 4.8 for the first setup and 3.6 for the second. The average computational costs of the entire inverse optimization process for Setup 1 and Setup 2 are approximately 1 h and 30 min and 1 h, respectively.

For the first setup, the giant difference in the geometry, aspect ratio, and, potentially, size between the undeformed gap and the apple-shaped target makes the problem highly challenging. The optimized design is shown in FIG. 11 part B, which demonstrates the accurate realization of the apple-shaped opening. The five bar-like members attached to the supports have directors parallel to their overall orientations, which pulls and expands the gap into a much larger opening. The small LCE members at the top produce the large curvature at the top of the opening. While the basic mechanism is clear, the shapes of the members are finely tuned by the optimizer to accurately fit the complex target shape.

The optimized design of the second setup is shown in FIG. 11 part B, demonstrating the accurate attainment of the flower-shaped target. The distribution of the LCE is highly complex and varies intensively along the boundary of the opening to generate the fluctuating curvature while several members with larger sizes are attached to the support to pull and expand the opening. The complex LCE distribution produces highly nonlinear deformations as demonstrated by the severely distorted LCE members in the deformed configuration. Such non-uniform LCE distributions are beyond the reach of intuition.

The non-uniformity of the control points can be seen in the deformed boundary shown in FIG. 11 part C. The distribution is dense in the concave regions and loose in the convex parts. As reviewed in the zoomed-in view of FIG. 11 part C, the difference in the segment lengths can reach over 6 times, which showcases the strength and robustness of the curvature-based formulation of Equation 16.

### 3. LCE Actuators

In this subsection, LCE actuators are generated that maximize output displacement (and energy) induced by LCE's spontaneous deformation upon temperature change. The large spontaneous deformation makes LCE a strong candidate for thermomechanical actuation, especially for soft structures. Existing ways of actuation that output mechanical work mainly rely on the material-level axial contraction of LCE. However, for more sophisticated boundary conditions, how to optimize the LCE structure to maximize output work remains underexplored. Also, the interplay between LCE and passive material in the context of generating actuation is unclear.

For the LCE actuator, the optimization of structural topology through the density design variable ρ is included in addition to material distribution. Also, passive materials with a much higher stiffness than LCE's are considered. This is in contrast to previous applications where only the material distribution is optimized, and the passive material is soft. As will be demonstrated later, the high stiffness of passive material promotes larger actuation.

The penalization parameters p and pr are both set to 3. For the Heaviside parameters β_{ρ} and β_{ξ}, a continuation scheme is applied as the following. Both parameters are initially set to 1, then β_{ρ} starts to increase at the 100th step by a factor of 2 until reaching 64 at the 220th step, and then β_{ξ} starts to increase with the same pattern until reaching 64 at 340th step. The maximum optimization step is set to 360.

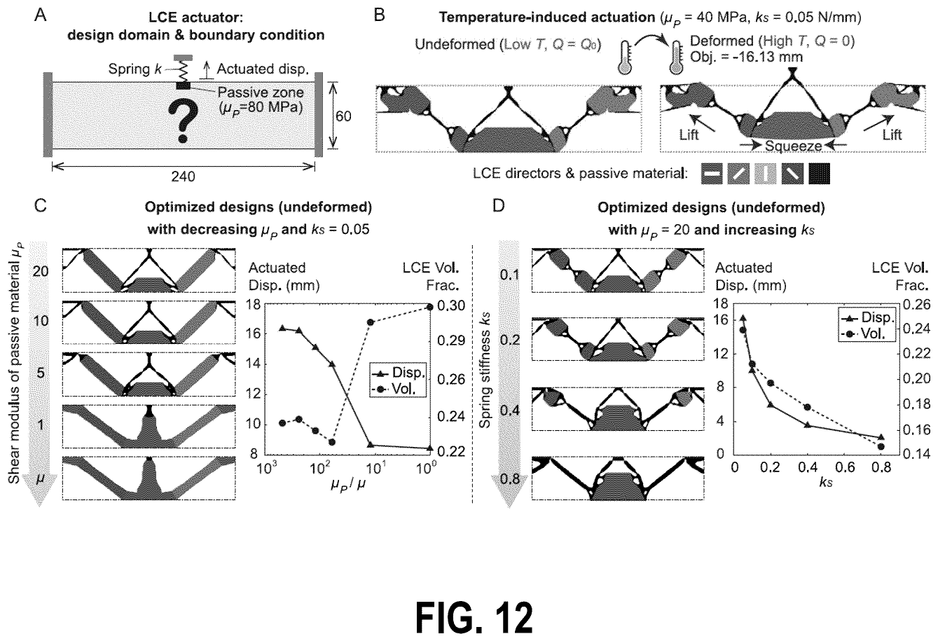

The optimization setup of the LCE actuator is shown in FIG. 12 part A. The size of the rectangular domain is 240 by 60 mm. The domain is fixed on both sides and connected to a spring at the mid-point of the top surface. The spring mimics the stiffness of the external structures being actuated by the LCE structure and measures the actuation power. To exploit symmetry, the right half of the domain is used for the optimization where the original axis of symmetry is constrained laterally by rollers. For passive materials, a wide range of stiffness with shear modulus ranging between the one of LCE (0.0823 MPa) to 40 MPa can be investigated. For the spring's stiffness k, a range from 0.05 N/mm to 0.8 N/mm can be considered. To remove the potentially excessive concentration of deformation near the spring region, a small passive zone is made of 80 MPa passive material as indicated in FIG. 12 part A. The FE mesh for the half domain is 240 by 120, and the filter radius is 3.6 mm. The average computational cost is approximately 2 h and 30 min.

The optimization objective function for maximizing actuation displacement is

$$J ( ρ , ξ , u ( ρ , ξ ) ) = l \cdot u ( ρ , ξ ) \qquad ( 18 )$$

Where the constant vector l extracts the y displacement of the actuated node. Note that the density design variable ρ is included for the optimization of structural topology. Also, a 30% volume fraction constraint is imposed for the total (not respective) volume of LCE and passive material. The filter radii for density and material design variables are both 3.6 mm.

First investigated is the setup with μ_{P}=40 MPa and k=0.05 N/mm. The optimized design is shown in FIG. 12 part B with a maximized actuation displacement of 16.13 mm. Both the stiff passive material and LCE with 0-, 45-, and 135-degree orientations appear, indicating the optimizer's preference for a composite instead of a purely LCE structure. The passive material parts have detailed features such as holes and branches while the LCE parts are relatively bulky. The LCE directors largely align with the overall structural orientation. The 0-degree LCE at the bottom and 45- and 135-degree LCE at the left and right regions contract axially to efficiently squeeze and lift the passive slender bar connecting to the spring. The parts with passive materials serve as supports and connectors. At the top-left and top-right corners, the passive material forms a stiff truss and extends toward the center to serve as a stiff support for the LCE actuation. For other regions, the passive material form thin bars to connect different LCE parts. Note that the passive parts are separated instead of integrated as a complete structure for the latter would boost the overall structural stiffness and significantly impedes the actuation. Hence, the appearance and disconnection of passive materials are generally favorable for LCE actuators.

The stiffness of the passive material (relative to that of LCE) considerably impacts the optimized design and the output displacement. This is demonstrated in FIG. 12 part C, which shows the optimized designs and objective function values with μ_{P} decreasing from 20 to 0.0820 MPa (μ). The designs with 5≤μ_{P}≤20 form integrated LCE parts, and the passive material parts at the right support form triangular trusses that serve as supports. Those with μ_{P}≤5 is dominated by LCE with a significantly lower fraction of passive material, which is concentrated near the spring. In terms of output displacement, the decrease of μ_{P} reduces the output displacement in a nonlinear fashion as demonstrated in FIG. 12 part C. With large enough μ_{P}, the displacements seem to converge to a value of approximately 16.1; and when μ_{P} is close to μ, the output displacement also converges to a smaller value of approximately 8.2, which is about half of the value with high μ_{P}. The trend that stiffer passive materials increase output displacement is opposite to the observation in the shape-fitting function in Examples 1 and 2 where softer passive materials enable larger deformation. Also decreasing nonlinearly with μ_{P} is the volume fraction of the passive material, as demonstrated in FIG. 12 part C. When μ_{P} is close to μ, the optimizer favors purely LCE structures. It is expected that when μ_{P} is further decreased to be smaller than μ, passive material will remain absent in the final result.

The spring's stiffness also significantly influences the optimized design and output displacement as demonstrated in FIG. 12 part D, where the four results are obtained with a spring's stiffness of 0.1, 0.2, 0.4, and 0.8, respectively. As expected, stiffer springs results in lower actuation but in a nonlinear fashion as shown in FIG. 12 part D. Surprisingly, the increase in the spring's stiffness reduces the total amount of LCE in the final designs as demonstrated in the plot of LCE volume fraction-k relation in FIG. 12 part D, indicating that less LCE and more passive material are more efficient for actuation with stiff springs. This seems to contradict the intuition that more actuating material should be favored for higher resistance. Also, as the k increases, the volumes of the 45- and 135-degree LCE reduce while the volume of 0-degree LCE increases. This shows that, in generating actuation, the squeezing effect provided by the 0-degree is more efficient than the lifting effect produced by the 45- and 135-degree LCE.

### E. Example Manufacturing Procedures Using Optimized LCE Models

The computational framework disclosed herein directly enables the physical fabrication of thermo-responsive structures with prescribed morphologies. The output of the optimization process includes detailed spatial maps of material distributions and director orientations for liquid crystal elastomer (LCE) composites. These design outputs can be translated into fabrication instructions for manufacturing systems capable of producing heterogeneous, anisotropic LCE structures.

Specifically, the optimized LCE director fields can be implemented through controlled alignment of mesogens during the fabrication process. Techniques such as photo-alignment, magnetic field alignment, shear-induced alignment, or mechanical stretching during crosslinking can be employed to physically embed the optimized director orientations into the LCE matrix. Either the “frozen-director” scenario (in which the director is locked to the polymer network) or the free-rotation model are realizable depending on the fabrication conditions (e.g., nematic vs. isotropic genesis and crosslink density).

The optimized geometries and material layouts produced by the topology optimization framework are compatible with additive manufacturing and mold-based techniques. For example, the multimaterial designs consisting of multiple LCE regions with differing director fields as well as passive elastomeric regions can be fabricated using multi-material 3D printing systems capable of depositing different materials or varying alignment conditions layer by layer. Alternatively, molds or lithographic masks can be created based on the optimized design to pattern the LCE and passive regions using established casting or photopolymerization methods.

To enable physical instantiation of the curvature-based design outputs, the optimized director fields and LCE topology may be used to generate toolpaths or processing maps for fabrication. These may include digital masks for photo-alignment or programming files for direct-ink writing systems that spatially control alignment and material composition. Furthermore, the system can be calibrated to account for fabrication-induced variations by adjusting the model parameters to better predict and correct for deformation outcomes.

### F. Example Operations

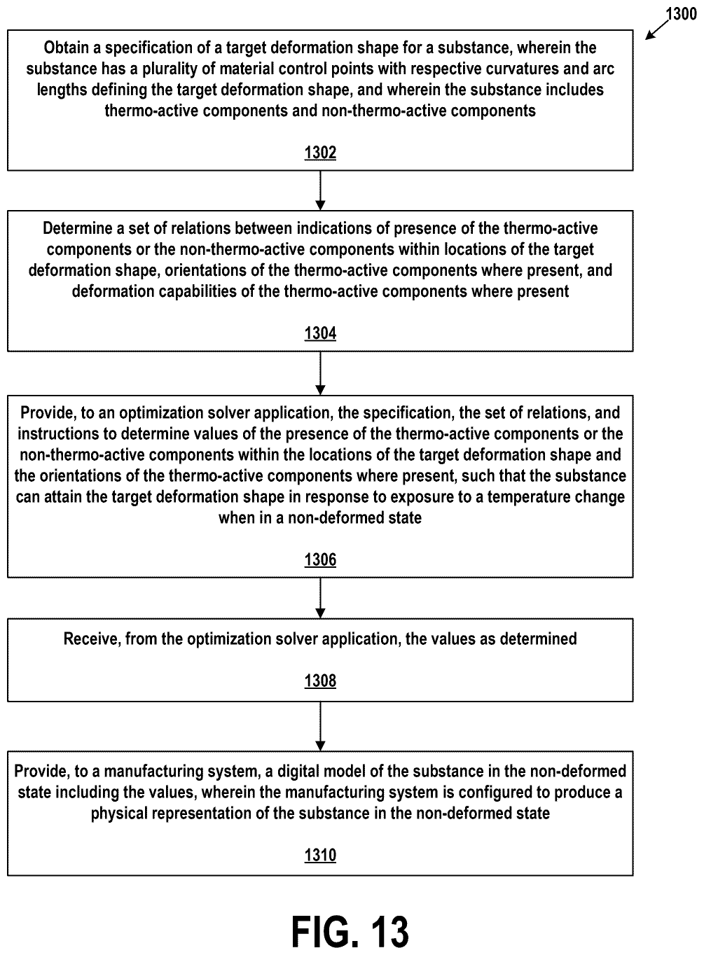

FIG. 13 is a flow chart 1300 illustrating an example embodiment. The process illustrated by FIG. 13 may be carried out by a computing device, such as computing device 100, and/or a cluster of computing devices, such as server cluster 200. However, the process can be carried out by other types of devices or device subsystems.

The embodiments of FIG. 13 may be simplified by the removal of any one or more of the features shown therein. Further, these embodiments may be combined with features, aspects, and/or implementations of any of the previous figures or otherwise described herein

Block 1302 may involve obtaining a specification of a target deformation shape for a substance, where the substance has a plurality of material control points with respective curvatures and arc lengths defining the target deformation shape, and where the substance includes thermo-active components and non-thermo-active components.

Block 1304 may involve determining a set of relations between indications of presence of the thermo-active components or the non-thermo-active components within locations of the target deformation shape, orientations of the thermo-active components where present, and deformation capabilities of the thermo-active components where present.

Block 1306 may involve providing, to an optimization solver application, the specification, the set of relations, and instructions to determine values of the presence of the thermo-active components or the non-thermo-active components within the locations of the target deformation shape and the orientations of the thermo-active components where present, such that the substance can attain the target deformation shape in response to exposure to a temperature change when in a non-deformed state.

Block 1308 may involve receiving, from the optimization solver application, the values as determined.

Block 1310 may involve providing, to a manufacturing system, a digital model of the substance in the non-deformed state including the values, where the manufacturing system is configured to produce a physical representation of the substance in the non-deformed state.

In some embodiments, the manufacturing system includes a 3D or 4D printing apparatus. These embodiments may further involve causing the 3D or 4D printing apparatus to produce the physical representation of the substance in the non-deformed state.

In some embodiments, the thermo-active components include liquid crystal elastomer components.

In some embodiments, the orientations are average orientations of groups of the liquid crystal elastomer components within the substance.

In some embodiments, the orientations are selected from 2-8 predetermined angles.

In some embodiments, the orientations become isotropic when the substance is heated to be above a transition temperature.

In some embodiments, the set of relations also involve a volume of the thermo-active components and a further volume of the non-thermo-active components.

In some embodiments, a predetermined total volume of the substance is a constraint on the set of relations.

In some embodiments, the optimization solver application is configured to determine the values using an iterative process, and wherein an iteration of the iterative process comprises: decomposing the substance into a material phase distribution on a finite element mesh; determining, based on the finite element mesh of the substance, the values of the presence of the thermo-active components or the non-thermo-active components within the locations of the target deformation shape and the orientations of the thermo-active components where present and deformation capabilities of the thermo-active components where present; and based on a gradient between the values and previous values from previous iterations of the iterative process, determining parameters for a new material phase distribution on the finite element mesh to be used in a subsequent iteration of the iterative process.

In some embodiments, the substance is formed as a solid strip with a length of at least 10 times its height and thickness.

In some embodiments, the substance is formed as planar sheet with the thermo-active components positioned on its edges.

In some embodiments, the optimization solver application is configured to attempt to maximize the deformation capabilities of the thermo-active components.

### G. Example Technical Improvements

These embodiments provide a robust inverse optimization framework for arbitrary shape programming of LCE composites under temperature-induced deformations. The framework is built upon a rigorous LCE model and multimaterial, multiphysics topology optimization with finite deformation. The curvature-based optimization formulation accurately captures the inherent geometry of the deformed configuration without being restricted by the overall orientation and scale of the structure. This offers a huge search space for optimization and allows for diverse realizations of any target shape. Several numerical examples have demonstrated the capacity and generality of the optimization framework in accurately achieving a wide range of target shapes with different complexities. For the actuation of LCE composites, passive materials with higher stiffness produce larger actuation and that the stiffness of the passive material and spring has significant but counterintuitive impacts on the optimized designs. The proposed framework facilitates systematic function-oriented creation of LCE structures, which will benefit applications such as active metamaterials, soft robotics, and environment-aware actuators.

Further, these embodiments provide a significant technical improvement in the design and control of thermo-responsive LCE composite structures by implementing a computational inverse design framework based on multiphysics topology optimization. This represents a practical application of mathematical techniques and material modeling to a technological field; namely, the programmable deformation of soft materials in response to thermal stimuli.

Traditional approaches to programming LCEs have relied on planar analytical models, direct fabrication techniques, or simplified models that treat LCEs as thermally expanding materials. These methods are limited in their ability to handle the nonlinear, anisotropic, and large-deformation behavior characteristic of LCEs, particularly in three-dimensional configurations or when precise curvature control is required. These embodiments overcome these limitations by introducing a finite-deformation topology optimization framework that incorporates a rigorously derived LCE constitutive model based on statistical mechanics, thereby capturing the material's spontaneous deformation and semi-soft elasticity with higher fidelity than conventional models.

As just one example, a technical improvement involves the use of a curvature-based inverse design formulation. Unlike position-based shape-matching methods, which are sensitive to rotation, translation, and scale, the curvature-based approach is inherently invariant to these transformations. It enables more robust and efficient optimization of the LCE's director distribution and material layout to match arbitrary target shapes, such as letters, numbers, and complex geometries. This enhancement allows for a more flexible and scalable design process, particularly suited to applications in soft robotics, biomedical devices, and adaptive structures.

The embodiments also involve integration of multimaterial characterization, which enables discrete representation of multiple LCE director orientations and passive material phases in a unified optimization framework. This multimaterial interpolation generates manufacturable designs that maintain physical realism while solving the inverse shape-programming problem. Furthermore, the method is compatible with nonlinear finite element analysis and uses adjoint sensitivity analysis for efficient gradient-based optimization, improving the computational tractability of solving large-scale design problems involving soft active materials.

Thus, these embodiments achieve a technical improvement by enabling systematic, programmable, and physically accurate control over the large, spontaneous thermal deformations of LCE structures. This capability is tied directly to physical materials and their manipulation using applied physics and engineering principles. It thus represents a specific and practical application.

IV. Programming LCEs with Continuous Director Orientations

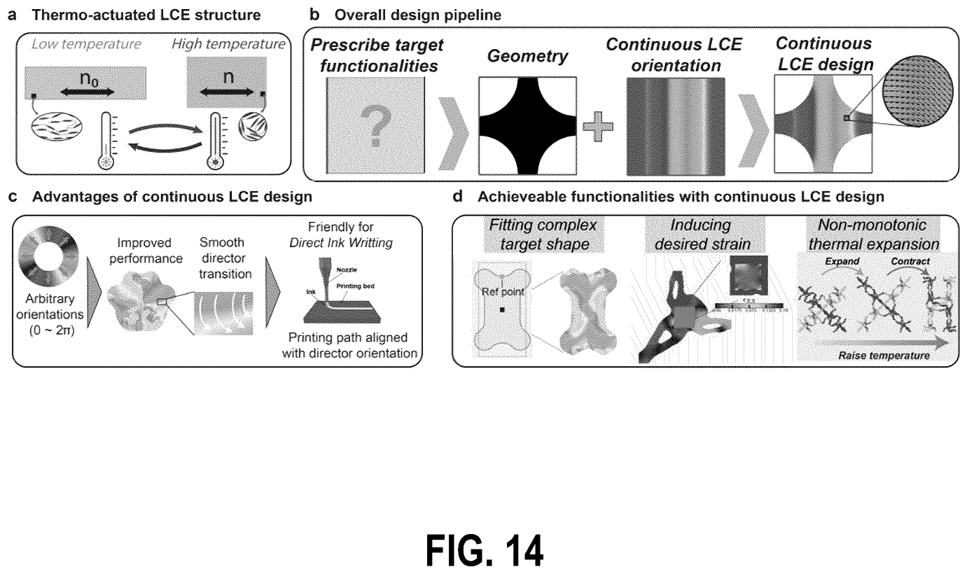

The embodiments herein provide a topology optimization framework for LCE that optimizes both the topology/geometry and the director distribution with a continuous orientation setup. A director orientation continuation filter is developed to first realign LCE directors in a continuous manner by considering their distinct physical properties, then apply a smooth filter to project the realigned directors into a continuous orientation pattern. Several optimization formulations enable optimized designs with diverse functionalities, including complex shaping morphing, desired strain inducing, and non-monotonic deformations under monotonic temperature rise. The design framework improves the density-based topology optimization approach that integrates LCEs' thermomechanical properties through a rigorous continuum model under finite deformation. This approach accurately captures the spontaneous deformation of LCE under multiphysical stimuli via nonlinear finite element analysis. The improved parameterization scheme allows for the simultaneous optimization of both geometry and continuous director orientation, ensuring a smoothly flowing director field within the optimized domain. As shown in FIG. 14 part C, the continuous orientation designs significantly enhance performance and facilitate fabrication compatibility, e.g., with direct ink writing (DIW)-based printing.

As used herein, a DIW printer refers to an additive manufacturing apparatus configured to deposit a viscoelastic material in a predetermined pattern through one or more nozzles under controlled motion. A DIW printer comprises a dispensing system, such as a syringe, piston, auger, or pressure-driven reservoir, coupled to at least one nozzle for extruding the material in a continuous filament. The printer further includes a positioning system, such as a multi-axis motion stage or gantry, for translating the nozzle relative to a build substrate in accordance with digital design data.

The viscoelastic material (referred to as “ink”) may include various types of polymers such as liquid crystal elastomers, or other compositions capable of maintaining their extruded shape until further curing or solidification. Curing or solidification may occur through one or more processes, including but not limited to photopolymerization, thermal curing, solvent evaporation, or chemical crosslinking.

The DIW printer may further include one or more auxiliary systems to condition the ink before, during, or after deposition, such as alignment fields (e.g., magnetic, electric, or shear-based), heating or cooling elements, ultraviolet or visible light sources, or mechanical compaction mechanisms. In some embodiments, the printer is capable of depositing multiple inks with different compositions, colors, or functional properties, through either multiple nozzles or sequential deposition from a single nozzle.

A DIW printer differs from conventional fused filament fabrication systems in that it does not require melting and re-solidifying a thermoplastic filament; instead, it extrudes inks in a semi-liquid or paste-like state that are formulated to retain the printed geometry upon deposition. This allows printing of a broader range of materials, including those with functional properties (e.g., stimuli-responsive polymers) and non-thermoplastic compositions.

### A. Continuum LCE Model

To rigorously model LCE's complex nonlinear behavior, a continuum LCE model is developed based on the neo-classical model, which is a statistical mechanics model considering order-related anisotropy. It is given in the form of free-energy density

$${W}_{FZ} ( F ) = \frac{μ}{2} [ \frac{1 - {Q}_{0}}{1 - Q} Tr ( C ) + ( \frac{3 {Q}_{0}}{1 + 2 Q} - ω ) {n}_{0} \cdot {Cn}_{0} - ( \frac{3 Q ( 1 - {Q}_{0} )}{( 1 - Q ) ( 1 + 2 Q )} - ω ) \frac{{n}_{0} \cdot {C}^{2} {n}_{0}}{{n}_{0} \cdot {Cn}_{0}} - 3 ] \qquad ( 19 )$$

Where C:=F^{T}F is the right Cauchy-Green deformation tensor, n₀ is the initial director (unit vector), and F is the deformation gradient with det(F)=1. Here, μ denotes the shear modulus and ω is the non-ideality parameter, for which μ=0.0829 and ω=0.0401, matching the measured physical properties of DIW-printed samples. The state variables Q₀, Q∈[0, 1] are initial and current order parameters that characterize the initial and current orientation order of the mesogens, respectively. They generally depend directly and nonlinearly on the initial and current temperatures. It is through the difference between Q₀ and Q that the model captures LCE's thermal actuation. For typical LCE material, it becomes mechanical isotropic when the temperature is above the LCE's critical transition temperature, corresponds to the loss of orientation order Q of the mesogens. However, in this context, isotropy primarily reflects the intrinsic physical properties of the LCE.

With the introduction of the non-ideal parameter w, the improved model of Equation 19 does not fully recover isotropy when Q₀=Q=0, but instead retains weak anisotropy. In contrast, the neo-classical model reduces to an isotropic Neo-Hookean form when Q₀=Q=0. However, the non-ideal model can still be employed since it can accurately capture LCE's complex nonlinear behaviors, including spontaneous thermal actuation, semi-soft elasticity, and stripe patterns. The model assumes a “frozen director” condition where the director rotates with the background macroscopic deformation. This assumption typically suits LCE with a nematic genesis that shows limited director rotation relative to the polymer backbone. Also, the assumption results in a single state variable of mechanical deformation, allowing for a more efficient solution of the nonlinear state equation than the models without the frozen director. Integration of the model of Equation 19 with topology optimization has been achieved recently but in an ideal discrete LCE director setup free of fabrication considerations. Here, the model is adapted to the continuous LCE director.

Various embodiments focus on the 2D plane stress scenario that assumes a thin LCE structure deforming in-plane. Applying the plane-stress condition of F₁₃=F₂₃=F₃₁=F₃₂=0 and det (F)=1 leads to the plane-stress version of the free energy density in terms of the planar deformation gradient F and director no

$$W ( \overline{F} ) = \frac{μ}{2} [ \frac{1 - {Q}_{0}}{1 - Q} ( Tr ( \overline{F} ) + \frac{1}{{\overline{J}}^{2}} ) + ( \frac{3 {Q}_{0}}{1 + 2 Q} - ω ) {\overline{n}}_{0} \cdot \overline{C} {\overline{n}}_{0} - ( \frac{3 Q ( 1 - {Q}_{0} )}{( 1 - Q ) ( 1 + 2 Q )} - ω ) \frac{{\overline{n}}_{0} \cdot {\overline{C}}^{2} {\overline{n}}_{0}}{{\overline{n}}_{0} \cdot \overline{C} {\overline{n}}_{0}} - 3 ] \qquad ( 20 )$$

Where J̅:=det(F̅) describes the LCE's ability to deform in 2D to locally change its area, accompanied by thickness variation in the out-of-plane direction. In the FEA, Q is decreased to actuate the system, effectively simulating a temperature increase that reduces the mesogens' orientational order. Equation 20 can be used develop the LCE topology optimization framework with continuous director distribution, focusing on versatile 2D in-plane applications.

### B. Design Parameterization and Energy Interpolation

### 1. Design Parameterization

These embodiments aim to optimize both the topology/geometry and the continuous director distribution of LCE structures. The density design variable ρ is adopted to characterize the geometry and propose an angle design variable ξ to characterize the director as indicated in FIG. 14. The density design variable is mapped to the physical density variable ρ through the standard density filter and smooth Heaviside projection.

Let xⱼ be the centroid coordinate of element j, and let νⱼ be the volume of element j. Nₑ(R_{ρ}) is defined as the set of neighboring elements for element e within the filter radius R_{ρ}:Nₑ(R_{ρ})={j|∥xⱼ−xₑ∥≤R_{ρ}}. The distance-based weight function w(xⱼ)=R_{ρ}−∥xⱼ−xₑ∥. Using these definitions, the filtered density \tilde{ρ}ₑ for element e is computed as

$${\tilde{ρ}}_{e} = \frac{{\sum }_{j ∈ {N}_{e} ( {R}_{ρ} )} w ( {x}_{j} ) {v}_{j} {ρ}_{j}}{{\sum }_{j ∈ {N}_{e} ( {R}_{ρ} )} w ( {x}_{j} ) {v}_{j}} \qquad ( 21 )$$

To further increase the discreteness of the final design, a Heaviside projection is applied to the filtered density. The projected physical density ρₑ, which represents the actual topology, is given by

$${\overline{ρ}}_{e} = \frac{tanh ( {β}_{ρ} {η}_{ρ} ) + tanh ( {β}_{ρ} ( {\tilde{ρ}}_{e} - {η}_{ρ} ) )}{tanh ( {β}_{ρ} {η}_{ρ} ) + tanh ( {β}_{ρ} ( 1 - {η}_{ρ} ) )} \qquad ( 22 )$$

Here, β_{ρ} is the parameter controlling the projection discreteness, which is gradually increased from 1 to 64 during this optimization procedure. The projection threshold η_{ρ} is set to 0.5. In some scenarios, other values can be used.

### 2. Special Alignment Filter for Angle Design Variable

For the topology optimization of LCE director distributions, a continuous director orientation scheme is adopted for two primary reasons. First, when compared to discretized designs, where directors can only choose from a few discrete candidate orientations, continuous orientation selection offers a much broader design space. This enables the realization of highly multifunctional designs with superior performance relative to conventional discretized approaches. Second, a continuous pattern enables unified, uninterrupted printing paths across the entire domain, eliminating the need to generate separate paths for each subdomain and to handle prestrained tensile forces at their interfaces. The continuous-design-facilitated uninterrupted printing paths also significantly reduce excessive ink oozing caused by frequent nozzle travel after finishing printing each subdomain when moving to the next working region.

In LCE director orientation optimization, two directors whose orientations differ by 180° (i.e., x radians) represent the same physical property. Rotating one director by 180° does not alter the physical behavior of that LCE element. Most existing continuation parameterization schemes present several potential issues.

One issue is that schemes regulating the Cartesian components of the vector, although the pointwise quadratic equality constraint can be relaxed into box constraints through isoparametric projection, the vector magnitude is no longer strictly controlled. As a result, the vector cannot always be guaranteed to remain a unit vector during optimization iterations, which conflicts with the LCE constitutive model requiring the director magnitude no to be exactly 1.

Another issue is that many filtering techniques applied directly to vector components tend to overlook the π-equivalence property inherent to LCEs. For instance, two adjacent directors n₀ and −n₀ represent the same physical state and do not require filtering. However, filters like the Helmholtz filter applied separately to each component can distort the vector field, potentially resulting in nearly perpendicular filtered vector or infinitesimal components and introducing singularities when reconstructing unit vectors.

Furthermore, polar-based continuation schemes that account for x-equivalence often require an additional judgment step to check whether adjacent element angles are within proximity, followed by a potential 180-degree rotation of one vector if necessary. This extra step increases computational cost and may disrupt the continuity of the filtering process.

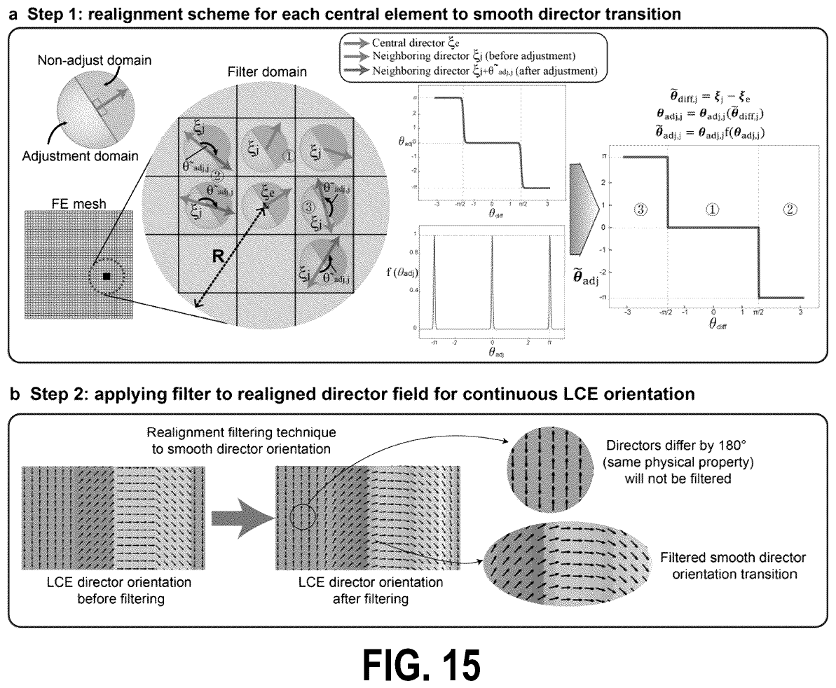

Accordingly, the embodiments herein employ a continuous parameterization strategy that accounts for the above director equivalence and pertinent considerations, which can filter a discrete LCE distribution into a continuous distribution. FIG. 15 part a illustrates different filtering scenarios.

Below is a review of the traditional density-based filtering strategy used in topology optimization. In such a strategy, a filter radius R is prescribed, and the design variable of the central element inside the filter domain is replaced by a weighted sum of all neighboring elements within that radius. Mathematically, for an element e, its filtered variable ξ̅ₑ is expressed as

$${ξ}_{e} = \frac{{\sum }_{j ∈ {N}_{e} ( {R}_{ρ} )} w ( {x}_{j} ) {v}_{j} {ξ}_{j}}{{\sum }_{j ∈ {N}_{e} ( {R}_{ρ} )} w ( {x}_{j} ) {v}_{j}} \qquad ( 23 )$$

$$Where$$

$${N}_{e} ( R ) = \{ j : ‖ {x}_{j} - {x}_{e} ‖ \leq R \}$$

is the neighborhood of element e defined by the filter radius R, in which xⱼ is the coordinate of the centroid of element j, where νⱼ is the volume associated with element j, and where w(xⱼ)=R−∥xⱼ−xₑ∥ is the linear (cone) weight function.

The embodiments herein use filter radii R_{ξ} when filtering the LCE director orientation variable ξ. Conceptually, this filtering strategy implements a convolution with a cone-shaped weight mask.

In this work, the above filtering framework is extended to handle the fact that rotating an LCE director by π yields an equivalent physical response. Specifically, each director variable ξ is restricted to lie in the interval

$$[ - \frac{π}{2} , \frac{π}{2} ] .$$

Because a rotation of π does not change the LCE mechanics property, the filtering procedure is modified to produce a continuous transition between neighboring elements. The purpose of the director continuation filter is to make it so that the central element's director orientation remains continuous with its surrounding pattern. To achieve this, a process can first identify all elements within the filter-defined neighborhood of the central element; these neighbors contribute to the weighted sum that updates the central element's director. Each neighboring director is then examined to determine whether it is sufficiently close in orientation to that of the central element. If not, the neighboring director is rotated by 180° (a physically equivalent operation) so that it more closely aligns with the central director. This realignment step is performed only for the purpose of updating the central element; it may differ when considering other elements as the “center.” Once this realignment is complete, the central element's director is recalculated (filtered).

This procedure gives rise to three main cases. Suppose ξₑ is the director angle for the central element, and {ξⱼ} for j∈Nₑ(R_{ξ}) are the directors in its filter neighborhood. Further θ_{diff}=ξⱼ−ξₑ.

The first case is

$$\vert {θ}_{diff} \vert \leq \frac{π}{2} .$$

No realignment is needed; ξⱼ is directly used in the filtered summation. The second case is

$$\vert {θ}_{diff} \vert > \frac{π}{2} . Since {ξ}_{j} - π$$

is physically equivalent to ξⱼ, using ξⱼ−π for filtering reduces the angle difference with the centric element and produces a smoother director transition. The third case

$${θ}_{diff} < - \frac{π}{2} Similarly , {ξ}_{j} + π$$

is physically equivalent to ξⱼ, again creating a smaller angle difference for filtering.

To avoid a discontinuous piecewise definition (which would introduce unwanted sensitivity discontinuities in the optimization), a smooth transition strategy is adopted, one that is inspired by the Heaviside projection in density-based topology optimization. Specifically, an “adjustment angle” θ_{adj} is defined as follows

$${θ}_{adj} ( {ξ}_{j} ) = - \frac{π}{2} tanh ( k ( {θ}_{diff} - \frac{π}{2} ) ) - \frac{π}{2} tanh ( k ( {θ}_{diff} + \frac{π}{2} ) ) \qquad ( 24 )$$

Here, k is a positive constant chosen to balance achieving smooth transitions among the distinct adjustment values {−π, 0, π} while avoiding destabilization of the optimization due to induced piecewise behavior. In numerical examples, k=1024, which results in a smooth director field while maintaining satisfactory optimization performance, as shown in FIG. 15 part b and the subsequent cases. Additionally, a continuously adaptive scheme for k could further improve optimization smoothness. Therefore, by using the tanh function instead of a hard threshold, θ_{adj} varies continuously inside the domain of angle difference.

A potential problem arises when

$$\vert {θ}_{diff} \vert is close to \frac{π}{2} .$$

In that case, the smooth projection in Equation 24 could shift ξⱼ by nearly

$$\pm \frac{π}{2}$$

unintentionally. Although this scenario is rare in practical optimizations, it can lead to abrupt director changes that can make the physical property of the ‘to be realigned’ director completely different, which will undermine the design. To address this, a Gaussian-based scaling factor f(θ_{adj}) is introduced that pushes θ_{adj} toward zero unless it is very close to −π, 0, or π. Specifically,

$$f ( {θ}_{adj} ) = exp ( - \frac{{( {θ}_{adj} + π )}^{2}}{{σ}^{2}} ) + exp ( - \frac{{θ}_{adj}^{2}}{{σ}^{2}} ) + exp ( - \frac{{( {θ}_{adj} - π )}^{2}}{{σ}^{2}} ) \qquad ( 25 )$$

Where σ is a small positive constant controls the width of the function peaks, for which σ=0.125 is used for numerical cases. Notice that f(θ_{adj})≈1 if θ_{adj} is near −π, 0, or π, and it is near 0 elsewhere. Then θ_{adj} is replaced with the scaled quantity

$${\tilde{θ}}_{adj} = {θ}_{adj} \cdot f ( {θ}_{adj} ) \qquad ( 26 )$$

The final filtered director \tilde{ξ}ₑ for element e can be written analogously to Equation 23, except that each ξⱼ in the numerator is replaced by (ξⱼ+\tilde{θ}_{adj,j}) and element density ρ for the corresponding weight, since a continuous director pattern is sought for solid fraction of design. Symbolically

$${\overline{ξ}}_{e} = \frac{{\sum }_{j ∈ {N}_{e} ( {R}_{ξ} )} w ( {x}_{j} ) {\overline{ρ}}_{j} {v}_{j} ( {ξ}_{j} + {\tilde{θ}}_{adj , j} )}{{\sum }_{j ∈ {N}_{e} ( {R}_{ξ} )} w ( {x}_{j} ) {\overline{ρ}}_{j} {v}_{j}} \qquad ( 27 )$$

This makes it such that if ξⱼ is physically equivalent (e.g., differing by π), the filter will favor the smaller angle difference, thereby preserving a smoother LCE director transition and improving overall continuity in the optimized design.

### 3. Interpolation of Energy

Based on physical variables ρ̅ and ξ̅, the energy interpolation rule is as follows

$${\tilde{W}}^{( e )} ( \overline{F} ; {\overline{ρ}}_{e} , {\overline{ξ}}_{e} ) = [ ϵ + ( 1 - ϵ ) {( {\overline{ρ}}_{e} )}^{{P}_{ρ}} ] [ {W}^{( e )} ( {γ}_{e} ( {\overline{ρ}}_{e} ) \overline{F} ; {\overline{ξ}}_{e} ) - {W}_{PL} ( {γ}_{e} ( {\overline{ρ}}_{e} ) \overline{F} ) + {W}_{PL} ( \overline{F} ) ] \qquad ( 28 )$$

Where P_{ρ} is the penalization parameter, ∈=10⁻⁶ is a small number to prevent singularity, and γₑ is a mapped variable of ρ̅ₑ used to prevent the instability issue of finite-deformation topology optimization through a special interpolation scheme as follows

$${γ}_{e} ( {\overline{ρ}}_{e} ) = \frac{tanh ( {β}_{γ} {ρ}_{min} ) + tanh ( {β}_{γ} ( {\overline{ρ}}_{e}^{p} - {ρ}_{min} ) )}{tanh ( {β}_{γ} {ρ}_{min} ) + tanh ( {β}_{γ} ( 1 - {ρ}_{min} ) )} \qquad ( 29 )$$

Where ρₘᵢₙ=0.01 is the projection threshold, and β_{γ}=500 is chosen to produce near-discrete behavior (γₑ≈1 for non-void elements and γₑ≈0 for void elements).

In the above expressions, W^{(e)}(γₑF̅) is the plane-stress LCE energy density specified earlier, and

$${W}_{PL} ( \overline{F} ) := \frac{1}{2} \overline{ϵ} : \overline{ℂ} : \overline{ϵ}$$

is a linearized plane-stress stored-energy function used for near-void regions to avoid numerical instabilities, specifically convergence issues in Newton-Raphson iterations during nonlinear FEA caused by excessive distortion elements in low-stiffness, near-void regions. Here, [symbol] is the plane-stress isotropic elastic tensor determined by the LCE's shear modulus u.

### C. Nonlinear FEM and Sensitivity Analysis

### 1. Nonlinear FEM

The finite element method (FEM) is employed to solve the elastostatic problem in the context of LCEs, applying a loading condition of Q≠Q₀ to simulate temperature changes. A standard displacement based two-dimensional FEM with a total Lagrangian formulation is used, employing quadrilateral bilinear elements and four Gauss points for numerical integration.

In the finite element discretized domain, the global displacement vector u at the equilibrium of the LCE composite, defined by parameters ρ and ξ is calculated by minimizing the total potential energy Π(ρ, ξ, ν) with respect to the global displacement vector ν. The solution can be formulated as

$$u ( \overline{ρ} , \overline{ξ} ) J = arg {min}_{v ∈ S} \prod ( \overline{ρ} , \overline{ξ} , v ) := {\sum }_{e} {\int }_{{Ω}_{0} , e} {\tilde{W}}^{( e )} ( \overline{F} ( {v}_{e} ) ; {\overline{ρ}}_{e} , {\overline{ξ}}_{e} ) d Ω \qquad ( 30 )$$

where S is the set of kinematically admissible displacements, Ω₀, e denotes the domain of element e in the undeformed configuration, vₑ is the element displacement vector and \tilde{W}ₑ is given in Equation 28. The equilibrium condition is such that

$$r = \frac{\partial \prod ( \overline{ρ} , \overline{ξ} , v )}{\partial v} = 0 \qquad ( 31 )$$

The nonlinear problem of Equation 31 is solved using the Newton-Raphson method where the tangential stiffness matrix is the Hessian of Π, i.e., K(ρ̅, ξ̅, v):=∂²Π(ρ̅, ξ̅, v)/∂v².

### 2. Sensitivity Analysis

The adjoint method for sensitivity analysis is adopted, and, given the various objective functions and constraints considered in this study, only a general form of the sensitivity expression is presented, which can be readily applied to all relevant functions. In general, the sensitivity of a general function ϕ(ρ̅, ξ̅) (which can be the objective or constraint functions) with respect to ρ̅ and ξ̅ are computed by

$$\frac{\partial ϕ}{\partial \overline{ρ}} = \frac{\partial ϕ ( \overline{ρ} , \overline{ξ} , u )}{\partial \overline{ρ}} {\vert}_{u} + {λ}^{T} \frac{\partial r ( \overline{ρ} , \overline{ξ} , u )}{\partial \overline{ρ}} \qquad ( 32 )$$

Where u is the structural displacement vector and λ is the adjoint variable obtained by solving the adjoint linear system

$${K}^{T} ( \overline{ρ} , \overline{ξ} , u ) λ = - \frac{\partial ϕ ( \overline{ρ} , \overline{ξ} , u )}{\partial u} \qquad ( 33 )$$

The sensitivity with respect to ξ̅ is obtained with the same procedure and is not repeated herein. The sensitivity with respect to the design variable ρ is obtained by applying chain rule based on Equations 32 and 33 as

$$\frac{\partial ϕ}{\partial ρ} = \frac{\partial ϕ}{\partial \overline{ρ}} \frac{\partial \overline{ρ}}{\partial \tilde{ρ}} \frac{\partial \tilde{ρ}}{\partial ρ} + \frac{\partial ϕ}{\partial \overline{ξ}} \frac{\partial \overline{ξ}}{\partial \overline{ρ}} \frac{\partial \overline{ρ}}{\partial \tilde{ρ}} \frac{\partial \tilde{ρ}}{\partial ρ} \qquad ( 34 )$$

Since the filtered physical director angle is also partially determined by ρ̅, and the sensitivity with respect to the director orientation design variable ξ is

$$\frac{\partial ϕ}{\partial ξ} = \frac{\partial ϕ}{\partial \overline{ξ}} \frac{\partial \overline{ξ}}{\partial ξ} \qquad ( 35 )$$

The sensitivity is input to the gradient-based Method of Moving Asymptotes algorithm for iterative updates of design variables.

### 3. Continuation for Improved Convergence

To improve the convergence of the optimizer and ensure high-quality designs, several parameters are gradually adjusted throughout the optimization process. This incremental approach allows us to progressively increase the discreteness of the design while fully exploiting the material's capabilities. In particular, the density penalization P_{ρ} is initialized at 2.0 and increased by 0.2 every 20 steps starting from step 30, until it reaches 3.0. Meanwhile, the Heaviside projection power β_{ρ} is initially set to 1 and, after P_{ρ}=3, β_{ρ} is doubled every 15 steps until it reaches 64. The continuation strategy applies only to density optimization. In addition, to reduce computational costs, first a coarse-mesh optimization is run and then the design is extrapolated onto a finer mesh for a second-stage optimization. For the first family of designs, to improve the actuation performance of the LCE sheet, the proposed director continuation filter is applied only after completing the first stage in a fully discrete setting; thereafter, 40-50 optimization steps are performed with the director filter activated.

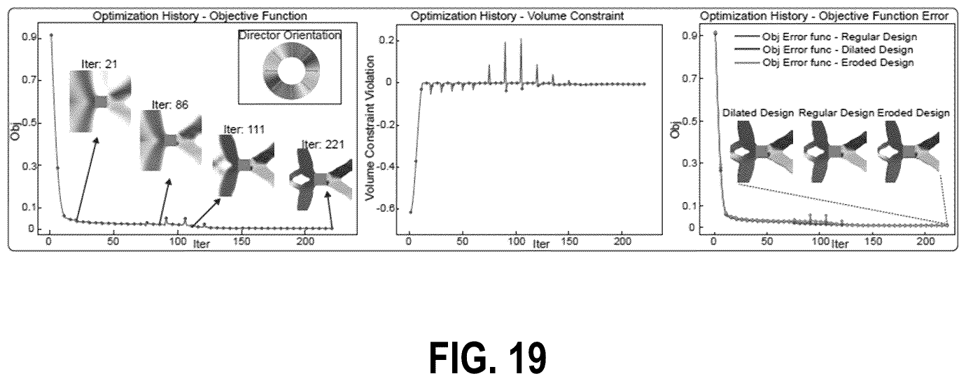

Regarding the termination criterion for the optimization procedure, the relative change of the objective function is set to be smaller than 10⁻⁴ and a maximum iteration step larger than 200 is defined, which may vary for different cases based on their specific behavior. This approach applies because topology optimization serves primarily as a design tool to achieve versatile LCE structures rather than to emphasize strict mathematical convergence. As shown in FIG. 19, the objective function curve consistently levels off before reaching the maximum iteration step, indicating that the current scheme does not suffer from premature termination. To balance the trade-off between the highly nonlinear, time-consuming FEA computations and achieving high-performance designs, this scheme was chosen and has yielded satisfactory results for multiple applications.

### D. Numerical Examples

The proposed LCE inverse design framework to generate LCE structures and metamaterials featuring continuous director fields and achieving wide-ranging complex thermo-active behaviors. The framework's capacity is demonstrated through three families of optimized LCE designs. For the first family, the temperature-induced morphing capability of LCE is used to realize programmable, accurate shape deformation under thermal actuation. For the second family, the focus is on biomedical applications harnessing the actuation capability of LCE, where LCE structures are optimized to provide precise strain control for a specific bio-tissue region. For the third family, the metamaterial setup is provided with a unit cell subjected to periodic boundary conditions and achieve non-monotonic thermal-induced area change under monotonic temperature increases.

### 1. Programming LCE Deformed Shape Under Thermal Actuation

As a thermal responsive material capable of undergoing large deformations, LCE is widely employed in various shape-morphing applications where it undergoes large deformation. To fully explore the potential of LCE's remarkable deformation ability, the focus herein is on programmable target shape fitting as the first family of inverse designs for LCEs with continuous director orientation. Although programmable deformation in LCEs has been explored, most approaches have selected either individual location fitting or purely heuristic designs. While these methods can provide relatively accurate fitting outcomes, they are highly vulnerable to rotation, transformation, and scaling of the final target. In addition, because the deformed position of the control points is generally unknown prior to actuation, existing methods cannot guarantee an optimally designed pattern for the desired shape. A key challenge is to find a variable that accurately and robustly represents the desired deformed shape of the LCE pattern.

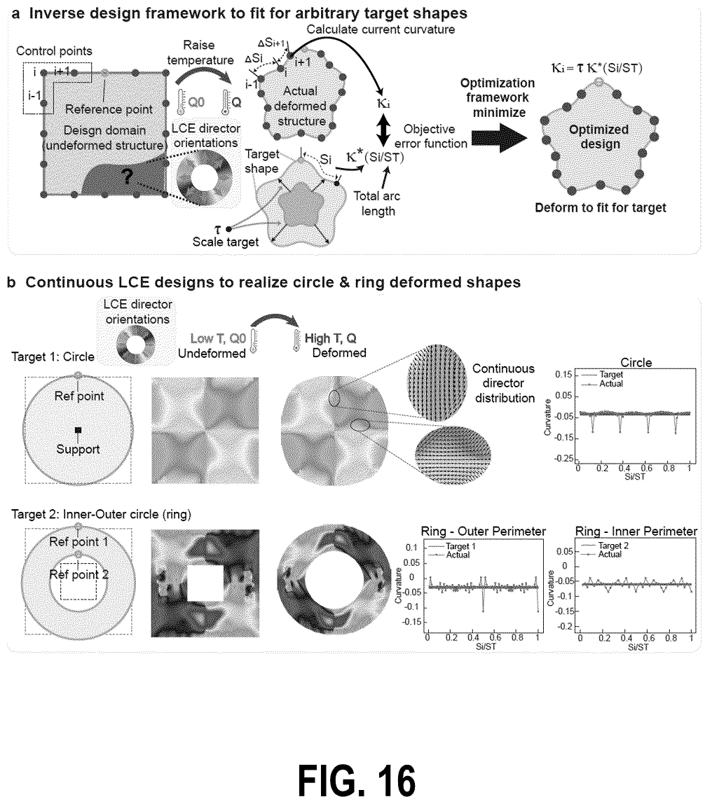

To address this issue, an adaptive curvature κ* is chosen that depends on the relative arc length, sᵢ/s_{T}, of each control point. Here, sᵢ is the arc length of the i-th control point (measured from a reference control point), and s_{T} is the total arc length. This curvature κ* serves as the fitting objective for the deformed shape of LCE. As illustrated in FIG. 16 part a, given any desired target shape, these embodiments first extract evenly distributed sampling points and a reference point on its contour, then to calculate the relative arc length and curvature at each sampling point, thereby obtaining the relationship between sᵢ, s_{T}, and κ* for any specific target shape, which implicitly reflects the target shape information. In terms of the optimization, the first step places multiple control points on the boundary of the LCE design domain, then for each control point, during optimization FEA is run to determine the relative arc length (measured from the reference point) and the local curvature after deformation, which is not known initially. Based on the relative arc length of each control points, the current step curvature targets are interpolated from the sᵢ/s_{T}−κ* mapping (relation constructed on sampling points) of the prescribed target shape.

The actual deformed curvature of each control point is numerically computed using a three-point finite-difference approximation of

$$κ ( s ) = {x}^{′} ( s ) {y}^{″} ( s ) - {y}^{′} ( s ) {x}^{″} ( s ) \qquad ( 36 )$$

The following discrete form is used

$${κ}_{i} = \frac{{x}_{i + 1} - {x}_{i - 1}}{Δ {s}_{i} + Δ {s}_{i + 1}} \frac{4 ( {y}_{i + 1} - 2 {y}_{i} + {y}_{i - 1} )}{{( Δ {s}_{i} + Δ {s}_{i + 1} )}^{2}} - \frac{{y}_{i + 1} - {y}_{i - 1}}{Δ {s}_{i} + Δ {s}_{i + 1}} \frac{4 ( {x}_{i + 1} - 2 {x}_{i} + {x}_{i - 1} )}{{( Δ {s}_{i} + Δ {s}_{i + 1} )}^{2}} \qquad ( 37 )$$

where Δsᵢ is the arc length between control points i and i−1, as illustrated in FIG. 16 part a.

To allow the optimized designs to target the desired shape of different scales (rather than a single fixed-size geometry), an additional design variable, τ, is introduced which serves as a scaling factor to adjust the target shape to a scale suitable for the current LCE deformation. As the LCE design evolves iteratively during optimization, τ is simultaneously updated to ensure the target shape remains compatible with the current deformation state.

Bringing these ideas together, the following objective function is for the inverse design of programmable LCEs to fit arbitrary shapes

$$J ( ρ , ξ , τ , u ( ρ , ξ ) ) = \frac{1}{2 N} {\sum }_{i = 1}^{N} {[ {κ}_{i} ( u ( ρ , ξ ) ) - τκ * ( \frac{{s}_{i} ( u ( ρ , ξ ) )}{{s}_{T} ( u ( ρ , ξ ) )} ) ]}^{2} \qquad ( 38 )$$

Where κᵢ is the curvature of the i-th control point in the deformed LCE design, κ* is the interpolated target curvature evaluated at the relative arc length sᵢ/s_{T}, and N is the total number of control points. τ is the aforementioned scalar design variable, serving as a scaling factor, which could also be a vector when fitting multiple shapes simultaneously (e.g., a ring target). During the optimization process, the error is minimized between the actual curvature and the target curvature in order to achieve the desired deformed shape.

With the specified form of the objective function for the first family of numerical examples, the following inverse optimization problem is formulated for the arbitrary deformed shape fitting application. In this problem, a goal is to vary the design variables in order to minimize a curvature-based error function while subject to volume constraints and the system equilibrium. Mathematically, the optimization problem is formulated as

$${min}_{ρ , ξ , τ} J ( ρ , ξ , τ , u ( ρ , ξ ) ) \qquad ( 39 )$$

$$Such that V ( ρ ) - {V}_{0} \leq 0 and {ρ}_{e} , ∈ [ 0 , 1 ] , {ξ}_{e} ∈ [ - \frac{π}{2} , \frac{π}{2} ] , e = 1 , … , n ,$$

with u(ρ, ξ) such that r(ρ, ξ, u)=0, wherein J(ρ, ξ, t, u(ρ, ξ)) is represents the curvature-based error function described previously in Equation 38. To ensure the design does not exceed the maximum allowable volume fraction V₀, the constraint V(ρ)−V₀≤0 is imposed. If, however, the density ρ is not treated as a design variable in some particular cases as the topology is fixed to only optimize the director orientation, this constraint is relaxed by choosing V₀ sufficiently large (e.g., 10,000). The last condition of Equation 39 is enforced by solving the nonlinear FEA equilibrium equations discussed above.

Another optimization design is of 2D planar LCE structures, aiming to achieve precise deformation into prescribed shapes upon thermal actuation. As stated previously, such designs hold significant potential for applications in soft robotics and medical devices. Through a series of numerical examples associated with the first family of designs, it is demonstrated that the proposed inverse design framework can generate non-intuitive optimized designs that accurately achieve arbitrary target shapes with complex contours, achievements that are beyond the capabilities of experience-based intuitive design.

To implement the curvature-based optimization framework and to control the deformation of the design, control points are uniformly distributed along the circumference of the undeformed shape. Upon actuation, the local lengths between these control points vary significantly, with each control point targeting an updated curvature value determined by the general curvature-based formulation.

To make it so that the designs are fabrication-friendly, only the LCE director orientation in the current family of designs (excluding ρ) is optimized. The LCE parameters are set to μ=0.0829, and ω=0.0401. For the LCE director orientation, its distribution is made continuous by employing the realignment filter described above. Each director orientation is constrained within the domain [−π/2, π/2], capable of accounting for a complete domain of director orientations (e.g. 0−2π). To adequately actuate the nematic-isotropic transition in the LCE and fit highly irregular targets, Q=0.63 and Q₀=0 are used for numerical simulations.

In the first example, a square sheet of LCE is optimized to deform into a circle, as shown in FIG. 16 part b. For the circle, the target curvature is k*=−1/R (where R is the radius), which is constant across all control points. The design domain (60 mm×60 mm) and the scaled target (using the optimized τ*) are illustrated in the left column of the figure. For this case, a relatively coarse finite element (FE) mesh (60×60 elements) and 80 control points are used. To ensure a continuous director orientation, the filter radius is set to 0.06×dimension Y=3.6 mm, with the domain fixed at the square's center.

The optimized design and its deformed shape are presented in the second and third columns on the left side of the figure. From the inset, it is observed that the director vectors are distributed continuously while accurately achieving the target shape. The comparison between the scaled target curvature and the actual curvature (FIG. 16) show that the curvature at different control points closely matches their scaled target curvature. The main errors occur at the corner points, which undergo significant deformation after actuation, to deform their initial corner intersection into a piece of smooth arc perimeter. Examining the optimized distribution of the LCE director orientation, the four sides are aligned with directors parallel to each boundary, causing contraction towards the sheet's center and compressing the structure into a circle. Meanwhile, the two main axes (dividing the four quadrants) feature directors aligned along the axes, facilitating elongation along these directions while maintaining smooth transitions between quadrants.

For the second target of fitting a ring structure, a different setup is employed. Specifically, a square opening with dimensions 20 mm×20 mm is within the square design domain, and the whole design domain is discretized in both directions by 120 elements (120×120 FE mesh), as illustrated in FIG. 16 part b. To achieve the desired ring shape, accurate control of both the outer contour and the inner opening after deformation is necessary. To this end, two sets of control points along the outer and inner perimeters, respectively, and assign each set distinct reference points and designable scaling factors-targeting the formation of two individual circles. For the objective error function, the errors from both the inner and outer perimeters are computed and summed. The sensitivity contributions from both perimeters are summed similarly, to supply gradient information for iterative optimization.

The optimized design (FIG. 16 part b) demonstrates accurate control over both the outer and inner contours, forming well-defined circles. For the LCE directors along the inner and outer circumferences, orientations are parallel to the respective boundaries, causing the inner opening to contract and the outer boundary to expand into two individual circles. Compared to the first example, this case achieves better circular shapes due to the central opening, which provides more void space for finite geometric deformation to achieve more complex shapes. Such intricate LCE distributions to achieve dual target shapes are beyond the scope of intuitive design.

To further explore the framework's capabilities, shapes with more complex, irregular geometries can be targeted using the general curvature-based formulation. This set of targets includes a star, a heart, a bone-like shape, and a paw-like shape. For the star, heart, and paw targets, a design domain of 60 mm×60 mm is used, fixed at the center. The filter radii are set to 4.5 mm, 3.6 mm, and 1.8 mm, respectively, for improved fitting effect. For the bone target, a rectangular domain (60 mm×30 mm) with a filter radius of 2.4 mm, also fixed at the domain center. As for the finite element (FE) discretization of each design, a 60×60-element mesh for the star and heart designs is used, as is a 120×60-element mesh for the bone design, and a 120×120-element mesh for the paw design, accounting for the increased complexity of the latter two targets. These targets involve non-convex circumferences and varying curvatures along their perimeters, unlike the circle's constant curvature. To obtain the target curvatures for each irregular shape, the target shapes are plotted by combining arcs and straight lines. Then the curvature is calculated along the boundary numerically, which is subsequently used as the target curvatures for the inverse design framework.

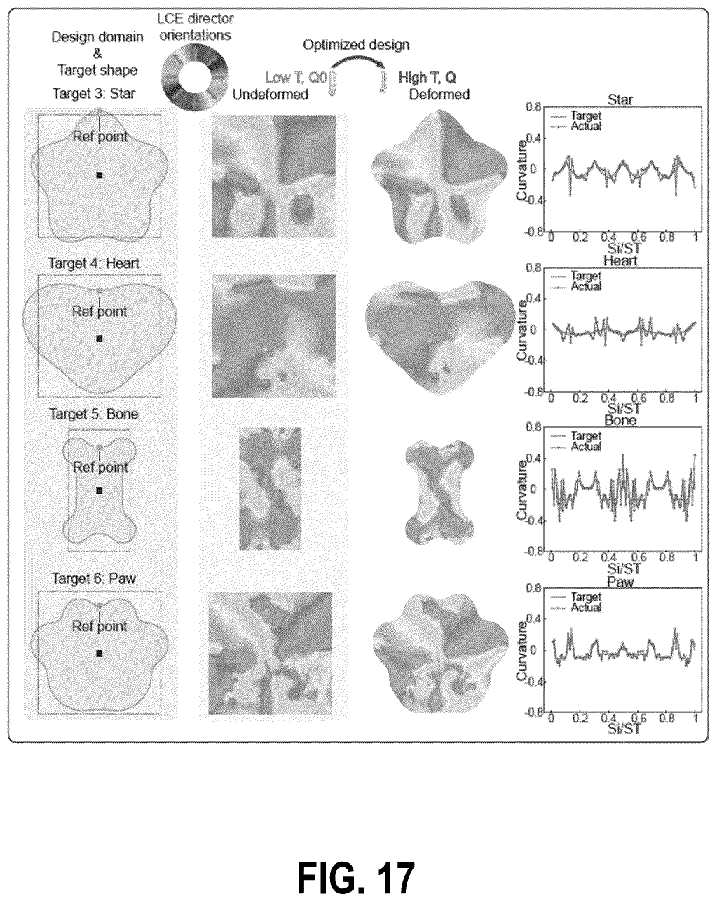

The optimized designs for the four targets are shown in FIG. 17. Each design accurately achieves its respective target, with each control points' target curvatures (after scaling with optimized τ) and their achieved curvatures shown as the rightmost column. For the star, the directors in the upper first quadrant align along π/4, symmetrically director align along −π/4 in the second quadrant, pulling the structure inward along the diagonal directions to form the concave segments between the upper three protrusions. Meanwhile, the lower two quadrants exhibit more intricate director patterns, enabling a complex and non-intuitive mechanism that creates a shallow indentation at the central bottom of the star, while maintaining stretched arms along the 4π/3 and 7π/4 directions. All together, these features achieve an accurate realization of the star target after deformation.

The second heart-target design is symmetrical about the Y-axis, featuring a concave notch at the upper central part and a comparatively sharper tip at the lower part. The target contour exhibits significantly varying curvatures. As shown in the third column of FIG. 17, the deformed optimized design accurately achieves the target heart shape. It features a smooth transition from vertically aligned directors in the upper quadrants to −π/4 directors occupying the lower regions. This distribution collectively enables contraction along the two lower diagonal directions, generating the protrusive tip, while simultaneously pulling the upper regions downward to create central inward warping.

To fit the third bone-target design, a smaller filter radius is applied to account for the reduced x-dimension and aim to achieve more sophisticated curvature variations, including zero curvature along the bilateral straight line segments and concave regions at the top and bottom. The optimized LCE design exhibits an intricate director distribution while maintaining a smooth transition between different regions—an achievement that would be nearly impossible using heuristic design methods. The irregular director distribution reveals a specific mechanism that elongates the top and bottom of the deformed shape while simultaneously contracting two bilateral sides horizontally, eventually forming the desired bone-shaped structure after deformation. However, for the “bone” sample, the error between the achieved and target curvature is slightly more noticeable. This results from minor post-processing to realign several directors that were not smoothly patterned in the continuous field. This adjustment is beneficial for potential DIW fabrication, and the resulting error remains within an acceptable tolerance.

Lastly, the paw shape presents the most challenging target, featuring drastic curvature variations along its contour. The optimized design incorporates subtle local LCE patterns near the boundaries to enable inward warping at the indentations and outward expansion at the protrusions. Such intricate and highly non-intuitive features are beyond the capabilities of heuristic or experience-based design methods. The proposed director orientation continuation filter ensures smooth transitions between various local patterns, making the design suitable for DIW printing. The resulting structure accurately deforms into the paw shape, demonstrating the framework's capacity for attaining highly sophisticated designs to deform into arbitrary complex shapes.

### 2. Large Deformation Compliant Mechanism for Inducing Desired Strain in Biological Tissues

Well-functional “mini-organ” models derived from adult stem cells closely resemble actual human organs. As a result, when novel drugs are tested on these models, the experimental outcomes are highly predictive of real effects on safety and efficacy in the human body. Consequently, such mini-organs have become widely sought after in the pharmaceutical industry. To facilitate the maturation of various tissue cells, uniaxial stretching of about 15% in mini-organs is required to attain proper contractile behavior. Hence, accurately controlling the strain distribution in the bio-tissue is desirable throughout the procedure. The objective of this application is to present a systematic LCE design method that can provide the required strain to the biological tissue under thermal stimuli.

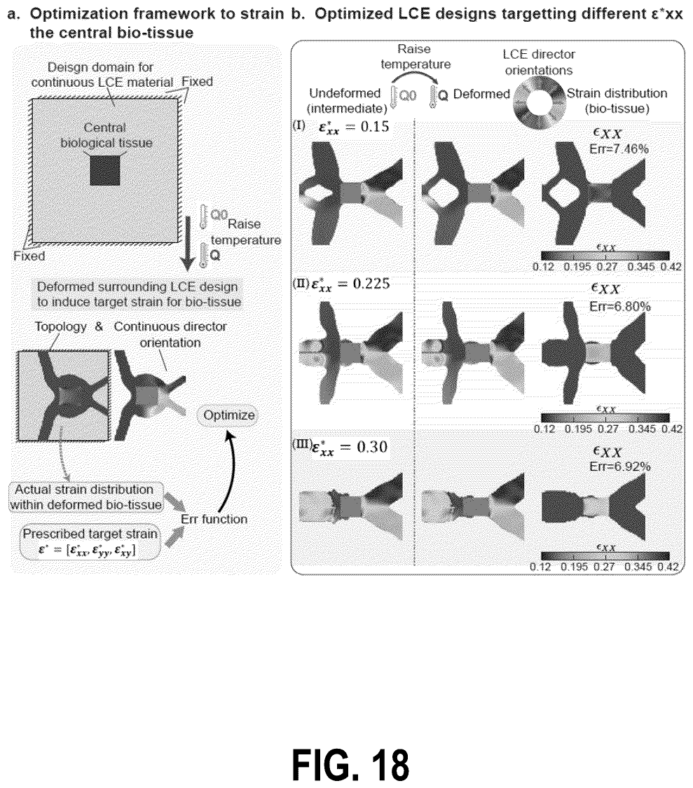

As illustrated in FIG. 18, a goal is to obtain an optimized LCE design in Ω₀, using the same overall design scheme as in the first application. This design should induce the prescribed target strain ∈* within the biological tissue region Ω_{BT} under thermal actuation.

Different from the first family of applications, and to avoid artifacts such as checkerboards or one-node-connected hinges, a robust formulation of the design problem is adopted via a min/max approach. Specifically, dilate and erode operations obtain three designs simultaneously—dilated, intermediate (the blueprint), and eroded—for the same optimization problem, then the worst (maximum) objective among them is minimized.

In the design framework, the dilated ρ̅^{d}, intermediate ρ̅, and eroded ρ̅^{e} projected densities are obtained through a Heaviside filter with thresholds 0.5−Δη, 0.5, and 0.5+Δη, respectively (Δη=0.05 in numerical examples). Mathematically, the robust min/max optimization problem is formulated as

$${min}_{ρ , ξ} max ( f ( u , {\overline{ρ}}^{d} ( ρ ) , {\overline{ξ}}^{d} ) , f ( u , \overline{ρ} ( ρ ) , \overline{ξ} ) , f ( u , {\overline{ρ}}^{e} ( ρ ) , {\overline{ξ}}^{e} ) ) \qquad ( 40 )$$

$$Such that$$

$$r ( u , {\overline{ρ}}^{d} ( ρ ) , {\overline{ξ}}^{d} ) = 0$$

$$r ( u , \overline{ρ} ( ρ ) , \overline{ξ} ) = 0$$

$$r ( u , {\overline{ρ}}^{e} ( ρ ) , {\overline{ξ}}^{e} ) = 0$$

$$V ( \overline{ρ} ( ρ ) ) - {V}_{0} \leq 0$$

$$ρ , ∈ [ 0 , 1 ]$$

$$ξ ∈ [ - \frac{π}{2} , \frac{π}{2} ]$$

Where r(u, ρ̅^{d}, ξ̅^{d}), r(u, ρ̅, ξ̅), and r(u, ρ̅^{e}, ξ̅^{e}) denote the residuals for the dilated, intermediate, and eroded designs, respectively, each requiring a separate nonlinear finite element analysis (FEA) to determine the equilibrium state. The function ƒ is the objective, defined by the error between the computed strain in the bio-tissue and the prescribed strain field required by the application. Beyond the formulated volume constraint for the LCE material, superfluous material is penalized using the term αV(ρ), with α set to 0.0002. This additional penalization term further suppresses unnecessary bulky regions when the volume constraint is already satisfied, helping to refine the final optimized structure without compromising the objective function value. The choice of a is intuitive and not based on a systematic parametric study. However, since this term is introduced primarily to achieve a geometrically refined design, its value is considered appropriate as long as it produces satisfactory results.

Under the assumption that

$${ϵ}_{xx}^{*} , {ϵ}_{yy}^{*} , and {ϵ}_{xy}^{*}$$

are the target strains in the x-, y-, and xy-directions, respectively. Then, the discrete form of f in the finite element setting is

$$f = \frac{1}{{N}_{be}} {\sum }_{e = 1}^{{N}_{be}} ( \frac{{{w}_{1} ( {ϵ}_{xx}^{e} - {ϵ}_{xx}^{*} )}^{2} + {{w}_{2} ( {ϵ}_{yy}^{e} - {ϵ}_{yy}^{*} )}^{2} + {{w}_{3} ( {ϵ}_{xy}^{e} - {ϵ}_{xy}^{*} )}^{2}}{{{w}_{1} ( {ϵ}_{xx}^{*} )}^{2} + {{w}_{2} ( {ϵ}_{yy}^{*} )}^{2} + {{w}_{3} ( {ϵ}_{xy}^{*} )}^{2}} ) \qquad ( 41 )$$

Where w₁, w₂, and w₃ are weighting factors for the three strain components, Ω_{BT} is the domain of the biological tissue (assumed to be a passive, Neo-Hookean material), and N_{be} is the number of discretized elements in that tissue domain. The quantities ∈ₓₓ, ∈_{yy}, and ∈_{xy} refer to the three entries of the Green-Lagrange strain

$$E = \frac{1}{2} ( {\overline{F}}^{T} \overline{F} - I ) ,$$

evaluated elementwise using the deformation gradient F̅ and expressed in Voigt notation. By integrating the squared strain error over the tissue domain in this manner, a goal is to ensure that the strain distribution throughout the bio-tissue meets the target.

Two sets of numerical examples are presented that demonstrate the capacity and efficacy of the inverse design framework to create optimized, continuous LCE structures capable of inducing prescribed strain in embedded biological tissue. In the first set of examples, the focus is on generating a uniaxial target strain in the x-direction (∈ₓₓ). Different target values are tested under the same level of actuation, showing that delicately adjusting the topology and director distribution of the LCE design can achieve a wide spectrum of desired strains for various applications. In the second set of examples, a goal is to explore different straining modes to highlight the generality of this approach for accommodating a variety of straining needs in the central bio-tissue, thus supporting multiple tissue maturation strategies. For the different optimization cases presented, specific volume fractions are selected to achieve satisfactory outcomes with lower error values, based on parameter trials. In particular, V₀=0.4 for Cases 1 and 2 in Set 1, and V₀=0.3 for the remaining samples. The square design domain has length L=10 mm and width W=10 mm. The embedded bio-tissue is represented by a dark, central square of 2 mm on each side. Both the density filter and director continuation filter have a radius r=0.8 mm. In the finite element analysis, the domain is discretized into 100×100 quadrilateral elements, with the central bio-tissue modeled by a Neo-Hookean material having a shear modulus μ=0.0829 MPa. This choice allows the tissue to be actuated by the surrounding LCE. All four edges (bottom, top, right, left) of the domain are fixed, as depicted in FIG. 18, and, unlike designs in the first family, both the topology (ρ) and LCE director orientations (ξ) in the lighter regions are optimized here.

To evaluate strain-fitting accuracy, the root mean square errors between the actual strain and the target strain can be defined. The following equations specify the root mean square errors for the x-, y-, and shear directions

$${Err}_{x} = \sqrt{f {\vert}_{{w}_{1} = 1 , {w}_{2} = {w}_{3} = 0}} \times 100 \% \qquad ( 42 )$$

$${Err}_{y} = \sqrt{f {\vert}_{{w}_{2} = 1 , {w}_{1} = {w}_{3} = 0}} \times 100 \%$$

$${Err}_{xy} = \sqrt{f {\vert}_{{w}_{3} = 1 , {w}_{1} = {w}_{2} = 0}} \times 100 \%$$

In the first set of examples, a goal is to optimize LCE designs that induce different values of axial strain in the x-direction for the central bio-tissue. According to the optimization formulation, w₁=1 and w₂=w₃=0, focusing solely on the x-direction strain. A symmetry about the x-axis is imposed for both the director field and the density distribution. For thermal actuation, Q₀=0.5 and Q=0.2, are chosen for maintaining a moderate temperature increase.

In a first case, the target strain

$${ϵ}_{xx}^{*} = 0.15 ,$$

an ideal value for maturing human stem cells in the bio-tissue. The optimized LCE layout, shown in FIG. 18, features two main LCE “limbs” connecting the tissue to the right boundary of the design domain. These limbs are occupied by directors aligned with their respective structural orientations and display a smooth transition between two principal directions. Meanwhile, two vertically extended arms attach the tissue on the left side to the top and bottom edges, carrying a uniform director orientation near 90°, two interconnected supporter growing from those two vertical structures to connect left boundary of the domain, offering further horizontal stretching capability.

After thermal actuation, the right-side LCE support takes the primary role of stretching the tissue axially in the positive x-direction, while the left-side LCE expands horizontally to move the tissue forward. Together, these contributions guide the strain distribution in the central tissue toward the target value. From the actual strain distribution and error value reported in FIG. 18, the strain distribution within the deformed tissue remains nearly uniform, and the error in the x-direction is around 7.46%. This outcome indicates that the optimized design closely approximates the desired strain state and shows strong promise for bioengineering applications.

The optimization history of this case is given in FIG. 19, showing (from left to right) the objective function history for the min/max formulation, the LCE volume constraint history, and the iteration histories for the eroded, regular, and dilated designs from the robust formulation. Although minor fluctuations occur when adjusting parameters such as Bp and Pp, the overall optimization proceeds smoothly thanks to the continuation scheme described above. Several intermediate results are shown as insets along the objective function curve, illustrating that the right-side support stabilizes early, while the more intricate interconnected left-side structure gradually forms over approximately 100 iterations, reaching convergence around iteration 130. This demonstrates that the final optimized structure results from a well-defined, continuous optimization process, without issues such as early termination or drastic fluctuations.

The next example examines larger target strains

$${ϵ}_{xx}^{*} = 0.225 and {ϵ}_{xx}^{*} = 0.3 ,$$

keeping the same level of actuation to demonstrate the framework's robustness under more demanding conditions. The optimized designs for these targets appear in the second and third rows of FIG. 18 part b, respectively.

When

$${ϵ}_{xx}^{*} = 0.225 ,$$

the optimizer favors a more substantial support connecting the left boundary of the domain to the tissue. This support has horizontally aligned directors that supply a stronger pulling force to stretch the tissue during actuation, thus achieving a larger x-axis strain. Due to the LCE volume constraint, the left-side vertical structures are reduced proportionally, reflecting the need for a stronger anchoring effect on the left side of the tissue. In FIG. 18 part b, the reported error of 6.80% between the actual and target strains confirms that the optimized structure successfully reaches the desired straining effect.

As the target strain further to

$${ϵ}_{xx}^{*} = 0.3 ,$$

the optimized LCE design in the third row of FIG. 18 is achieved. Following the same trend appearing in the previous example, there is a larger horizontal LCE region attached to the left boundary, occupied by directors at 0°, while the vertical LCE arms vanish entirely. This enlarged left-side structure generates a significant pulling force, allowing the right-side LCE region (unchanged across these three examples) to induce a higher strain after expansion, in order to meet the new target. The error between actual and target strain is 6.92% in the current design, indicating an even more precise realization of the target. Thus, under a single actuation level, the optimizer can effectively allocate LCE material and align its directors continuously to achieve multiple target strains.

Across the three samples presented above, it is observed that as the target

$${ϵ}_{xx}^{*}$$

value increases nom 0.13 to 0.3, the optimized LCE structures evolve to incorporate distinct features to meet their respective targets. In particular, there is a general trend of increasing fractions of 0-degree aligned directors connecting the left boundary to enhance horizontal stretching. While it cannot be guaranteed that each design is globally optimal for its scenario, their consistently low error values demonstrate the effectiveness and robustness of the proposed optimization framework.

In the second set of designs below, the focus is on producing different strain modes in the central bio-tissue to accommodate a variety of maturation requirements.

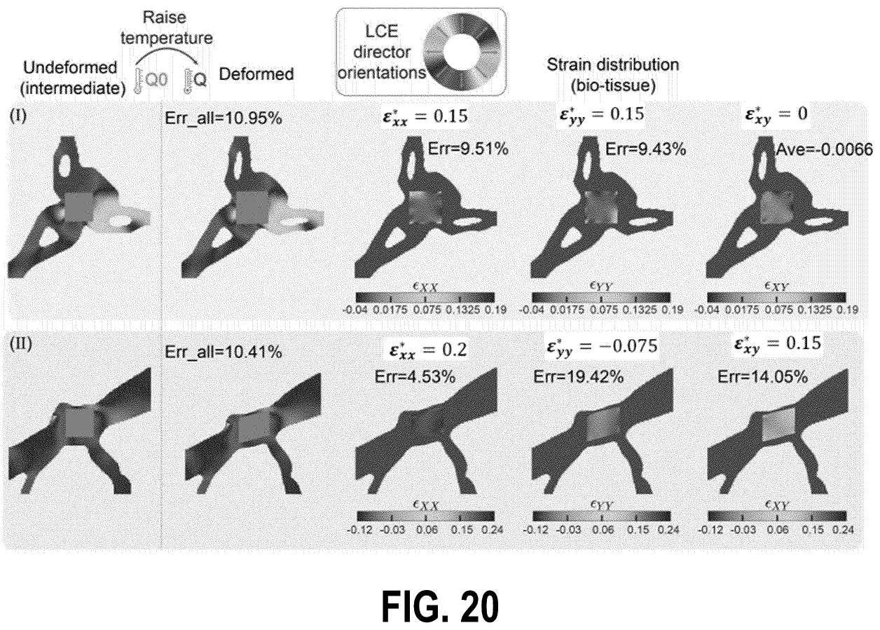

A first goal here is to induce a prescribed bi-axial strain to the bio-tissue. To do so, ∈* is set to [0.15 0.15 0] with w₁=w₂=w₃=1 so that all strain directions are accounted for. A 45° symmetry is imposed in both the density and director fields. Since a goal is to achieve more sophisticated straining modes, it is advantageous to actuate the LCEs to a greater extent, thereby leveraging their enhanced deformation capability to induce the desired strain in the target region. To this end, in the numerical implementation, the final Q is decreased and the initial Q₀ is increased to achieve a wider loading range and drive the LCEs closer to a fully isotropic state (Q=0). Accordingly, Q₀=0.5 and Q=0.02, which can be realized experimentally by adjusting the initial and final heating temperatures. The optimized design before and after deformation is shown in FIG. 20. Here, the LCE structure is predominantly oriented at 45°, surrounding the tissue and connecting it to the top and right edges via two supports distributed with directors at 90° and 0°, respectively, with a smooth transition between patterns. After heating, it expands the tissue both upward and rightward.

From FIG. 20, the strain errors for the x- and y-axes are 9.51% and 9.43%, respectively, confirming a close realization of the desired bi-axial stretching. Moreover, the average shear strain is approximately −0.0066 (since the denominator of the root mean square becomes zero, the average shear strain can be directly measured), very close to the target of

$${ϵ}_{xy}^{*} .$$

Hence, through deliberate design of both geometry and director orientation, the optimized LCE structure provides the targeted bi-axial expansion, which is beyond the scope of heuristic design methods, demonstrating the strength and effectiveness of the design framework.

Finally, a more general straining mode involving all three directions: €ₓₓ, ∈_{yy}, and ∈_{xy}. This time, symmetry is not enforced, which facilitates a non-zero shear component. Specifically, ∈ₓₓ=0.20, ∈ₓₓ=−0.075, ∈_{xy}=0.15, with w₁=w₂=w₃=1. The resulting optimized design and its deformed shape appear in FIG. 20. Two leg-like LCE supports connect the tissue to the bottom boundary, while a larger inclined LCE beam at roughly 45° encloses the tissue, accommodating directors that smoothly transition from 45° to approximately 80°. Together, these features enable shear-dominated deformation after heating, stretching the structure along 45° while compressing it perpendicularly.

From FIG. 20, the strain errors for the three directions are [4.53%, 19.42%, 14.05%]. Although the second component shows a slightly larger mismatch, overall the design satisfies the target strains sufficiently, confirming that the optimized LCE structure can induce axial, transverse, and shear strain objectives for the bio-tissue. The relatively larger error here could be attributed to (1) convergence to a local minimum or (2) an unreachable target due to design bounds. It is not caused by premature termination, as the objective function has converged before termination, as shown in the optimization history in FIG. 19.

3. Programmable Metamaterials with Non-Monotonic Thermal Expansion-Contraction Under Monotonic Temperature Rise

In this subsection, a goal is to realize programmable temperature-actuated behavior in a periodic LCE metamaterial. Specifically, both the geometry and continuous director orientation of a single LCE unit cell is optimized-later repeated to form a larger periodic assembly—in order to achieve non-monotonic area change under a monotonically increasing temperature. In more detail, as the temperature is raised, the macroscopic structure first expands to increase its area, but upon further temperature increase, it contracts to reduce its overall deployed size. Such a non-monotonic design may find applications in fields ranging from intelligent fabrics to advanced thermal-proofing infrastructure.

To optimize the LCE unit-cell design in the periodic metamaterial, the nonlinear FEA above is implemented, subject to periodic boundary conditions. Let “a” and “b” denote pairs of periodic counterpart nodes on opposite edges of a square unit cell, with X representing the nodal coordinates in the undeformed reference configuration. Under the periodic boundary condition, these node pairs satisfy

$${u}^{( a )} - {u}^{( b )} = {\overline{F}}_{ave} ( {X}^{( a )} - {X}^{( b )} ) \qquad ( 43 )$$

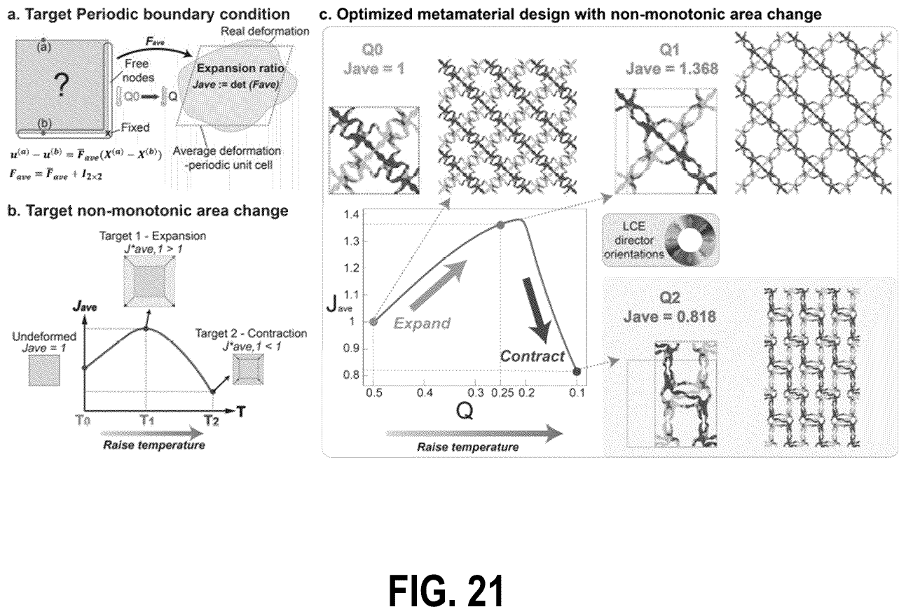

Which is illustrated in FIG. 21 part a, where F̅ₐᵥₑ is the averaged displacement gradient of the unit cell, whose components are determined through the finite element analysis. For purely thermal loading, all four components of F̅ₐᵥₑ can be solved for. For mechanical loading, for instance uniaxial tension along Y, one strain component can be prescribed (e.g., set F̅_{ave,YY}) and solve for the remaining three entries plus the nodal displacements in the nonlinear FEA.

To impose periodic boundary conditions in practice, a variable-separation technique is adopted that distinguishes the free nodal variables (those not subject to periodic constraints), including nodes on the two non-opposite sides and internal nodes. The degrees of freedom associated with these free nodal variables are assembled together with the unknown entries of F̅ₐᵥₑ to form the final set of free Dofs used in the FEA under periodic boundary conditions. These free Dofs are displacement as a separate vector ũ, with the mapping to the global displacement vector u given by

$$u = G \tilde{u} \qquad ( 44 )$$

Where G is a sparse, constant “mapping matrix” encoding the periodic constraints. In the nonlinear finite element analysis, minimizing the potential energy with respect to ũ becomes

$$\tilde{u} ( ρ , ξ ) = arg {min}_{v ∈ S} \prod ( ρ , ξ , \tilde{v} ) \qquad ( 45 )$$

Where Π is the total potential energy. By the chain rule through u=Gũ, the internal force and stiffness with respect to û become

$${\tilde{F}}_{int} = {G}^{T} {F}_{int} , \tilde{K} = {G}^{T} KG \qquad ( 46 )$$

where Fᵢₙₜ and K are the internal force and stiffness matrix in the original global system. And the mapped {Fᵢₙₜ, K} are defined upon the free Dofs that are not subjected to periodic boundary conditions, which are then used in a nonlinear Newton-Raphson algorithm to solve for equilibrium state iteratively.

With these periodic boundary conditions in place, the third family of designs targets the topology and continuous LCE director orientation of a single unit cell to achieve a spontaneous non-monotonic area expansion-contraction under thermal actuation. To increase design novelty and applicability (e.g., in thermal-proofing structures), a goal is to find a non-monotonic response: at moderate temperature increases, the unit cell should expand (increasing area to enhance heat absorption), whereas at higher temperatures, it should contract (shrinking area to protect the structure from excessive heat), as shown in FIG. 21 part b.

Mathematically, this can be formulated as an optimization problem. Let Jₐᵥₑ denote the determinant of the average deformation gradient Fₐᵥₑ=F̅ₐᵥₑ+I_{2×2}, in which I_{2×2} is the 2-by-2 identity matrix. The determinant Jₐᵥₑ stands for the area expansion ratio of the unit cell from its undeformed reference. Two target expansion ratios,

$${J}_{ave , 1}^{*} and {J}_{ave , 2}^{*}$$

are prescribed, corresponding to two distinct thermal load states during the monotonic increase of temperature: for example, Q₁=0.25 (moderate heating) and Q₂=0.1 (final heating state-high temperature), to enforce expansion in the first state and shrinkage in the second. In the present study,

$${J}_{ave , 1}^{*} = 5 and {J}_{ave , 2}^{*} = 0.4 . Let {J}_{ave , 1} ( \tilde{u} ) and {J}_{ave , 2} ( \tilde{u} )$$

denote the actual area expansion ratios at these two load states. However, the target

$${J}_{ave}^{*}$$

values are selected to guide the optimizer toward the desired non-monotonic response, rather than to be strictly achieved as exact target ratios. Because the two objectives are on different scales, separate weights are used to form a weighted-sum objective. As in the previous designs, a volume constraint V(ρ)≤V₀=0.5 and minimal stiffness constraints through the average tractions τₓ and τ_{y} are imposed, ensuring the cell can interconnect with adjacent cells meanwhile satisfying minimal stiffness constraint. These tractions are computed for two uniaxial load cases, one in the X direction and one in the Y direction, respectively, with the equilibria denoted by r₂=0 and r₃=0. In full, the optimization problem reads

$${min}_{ρ , ξ} \frac{1}{2} {{w}_{1} [ {J}_{ave , 1} ( \tilde{u} ( ρ , ξ ) ) - {J}_{ave , 1}^{*} ]}^{2} + \frac{1}{2} {{w}_{2} [ {J}_{ave , 2} ( \tilde{u} ( ρ , ξ ) ) - {J}_{ave , 2}^{*} ]}^{2} + α V ( ρ )$$

$$Such that$$

$$V - {V}_{0} \leq 0$$

$$- {τ}_{X}^{2} ( ρ , ξ , {\tilde{u}}_{2} ) + {\underline{τ}}_{X}^{2} \leq 0$$

$$- {τ}_{Y}^{2} ( ρ , ξ , {\tilde{u}}_{3} ) + {\underline{τ}}_{Y}^{2} \leq 0$$

$${ρ}_{e} , ∈ [ 0 , 1 ] , {ξ}_{e} ∈ [ - \frac{π}{2} , \frac{π}{2} ] , e = 1 , … , n$$

$${r}_{1} ( ρ , ξ , {\tilde{u}}_{1} ) = 0$$

$${r}_{2} ( ρ , ξ , {\tilde{u}}_{2} ) = 0$$

$${r}_{3} ( ρ , ξ , {\tilde{u}}_{3} ) = 0$$

Where the weights w₁=1 and w₂=2 are chosen to balance how closely each target is approached. The current values were selected based on multiple optimization trials, as it provided a good trade-off between structural integrity and non-monotonic performance. Since this choice successfully achieved the desired functionalities, it is appropriate for this specific application. Additionally,

$${τ}_{X}^{2} ( ρ , ξ , {\tilde{u}}_{2} ) \geq {\underline{τ}}_{X}^{2} = 0.0 \; 25 {kPa}^{2} and {τ}_{Y}^{2} ( ρ , ξ , {\tilde{u}}_{3} ) \geq {\underline{τ}}_{Y}^{2} = 0.0 \; 25 {kPa}^{2}$$

so that the final structure satisfies a minimal stiffness requirement. Here, similar to Equation 40, there is a penalization for superfluous material using the term αV(ρ), where α=0.0002 based on intuition and preliminary trials. Since the resulting nonmonotonic design does not exhibit obvious bulky regions therefore the penalty effectively fulfills its intended functionality, then this value is considered appropriate. By formulating and solving the above optimization problem, one can achieve a desired non-monotonic actuation response where the structure expands at moderate temperature and contracts at a higher temperature.

Additional embodiments involve the design of an LCE unit cell within a periodic metamaterial, applying the previously discussed periodic boundary conditions and multi-target optimization formulations. An objective is to optimize both the topology and the continuous director orientation of the LCE unit cell in order to achieve non-monotonic area change under monotonic thermal actuation (i.e., steadily increasing temperature). Such an optimized design can be applied to self-deployable thermal-protective structures that expand spontaneously at moderate temperatures but contract at higher temperatures upon further heating. For the optimization setup, a square design domain of size 10 mm×10 mm is considered, discretized into 120×120 finite elements. To generate highly interconnected structures, a small filter radius of r=0.3 mm is applied for both the density filter and the director continuation filter. Also, symmetry along both the x- and y-axes are imposed and a minimal stiffness constraint is introduced for axial load cases to maintain structural integrity and ensure connectivity to adjacent unit cells. Notably, the continuation filter need not be applied from the beginning. Instead, the director orientation can evolve freely in a fully discretized manner for the first 60 iterations in order to fully exploit the deformation potential of LCE and generate remarkable nonmonotonic behavior. After the initial 60 iterations, the continuation filter is applied for the following optimization iterations to obtain a smooth, continuous director field.

Using the proposed inverse design framework, an optimized LCE unit cell is obtained as depicted in FIG. 21. The undeformed configuration, along with its deformed shapes at two target states, is shown in FIG. 21 part c overlaid on the Q−J curve. For the macroscopic periodic metamaterial, the undeformed and deformed configurations of a 3×3 assembly are also illustrated alongside their unit-cell counterparts. The optimized unit cell features intricately curved, interconnected LCE members with a sophisticated continuous director distribution. When the temperature is raised to the first target state Q=Q₁, these curved inner members straighten, causing the cell to expand diagonally and increase its overall area. Consequently, it achieves an expansion ratio J_{ave,1}=1.368, which satisfies the expansion requirement for the first target.

To proceed further, the temperature is increased to reach the second target state at Q=0.1. During this stage of deformation, the centrally located cross-shaped LCE member with ±45° director orientations plays the dominant role, contracting and pulling the entire structure toward the right boundary of the design domain. As a result, the diagonally expanded shape, which initially occupies a square region, transitions into a contracted structure, which occupies a rectangular strip. At this point, the structure achieves an expansion ratio of J_{ave,2}=0.818, indicating the successful realization of the desired contraction mode at a high temperature. Hence, the design successfully exhibits the desired non-monotonic area change when the temperature is monotonically increased—expanding at a moderate temperature (first target) and contracting at a higher temperature (second target).

However, that the current design does not exactly match the prescribed target value

$${J}_{ave}^{*} .$$

Instead, the target values guide the structure toward non-monotonic behavior. Moreover, this optimized configuration is unlikely to be a global optimum due to the highly non-convex nature of the problem and its sensitivity to various parameters, including target weights, desired expansion/contraction ratios, and stiffness constraints. Reducing stiffness constraints might further amplify the non-monotonic behavior but could compromise structural integrity.

The non-monotonic deformation objective is also challenging due to a deficiency in the classical Topot parameterization approach, which does not explicitly address contact or overlap of solid material. Because this second design aims to achieve a certain degree of shrinkage, material overlapping was frequently observed in the numerical experiments. Consequently, a moderate actuation level of Q₂=0.1 was employed to mitigate its impact. Nonetheless, at the second target state Q=Q₂, the central LCE members nearly touch each other, indicating that further actuation could lead to overlap.

### E. Example Operations

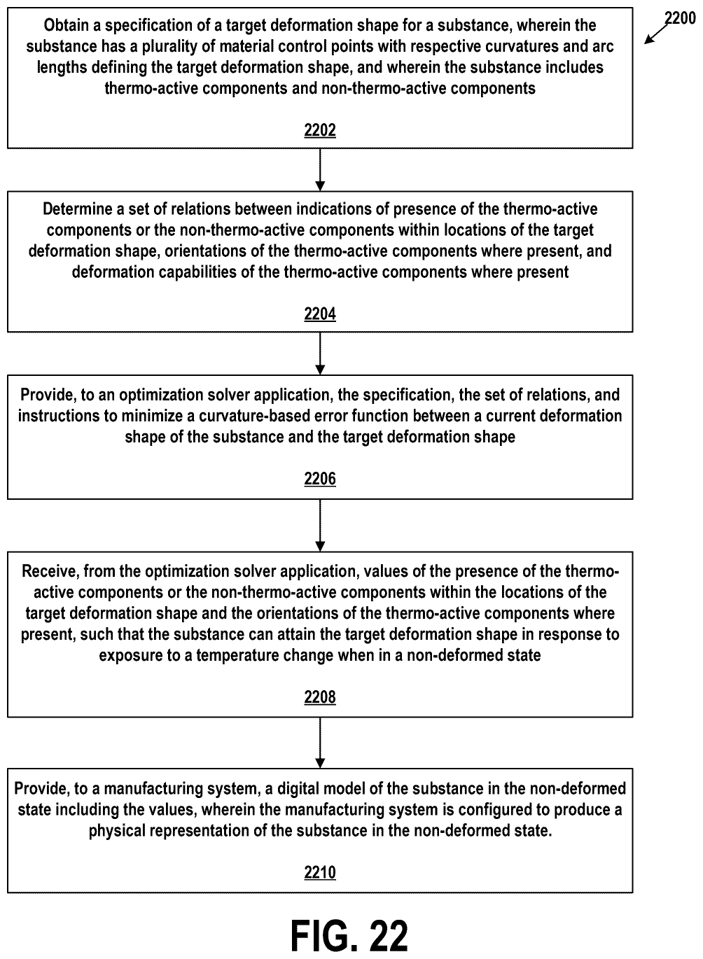

FIG. 22 is a flow chart 2200 illustrating an example embodiment. The process illustrated by FIG. 22 may be carried out by a computing device, such as computing device 100, and/or a cluster of computing devices, such as server cluster 200. However, the process can be carried out by other types of devices or device subsystems.

The embodiments of FIG. 22 may be simplified by the removal of any one or more of the features shown therein. Further, these embodiments may be combined with features, aspects, and/or implementations of any of the previous figures or otherwise described herein.

Block 2202 may involve obtaining a specification of a target deformation shape for a substance, wherein the substance has a plurality of material control points with respective curvatures and arc lengths defining the target deformation shape, and wherein the substance includes thermo-active components and non-thermo-active components.

Block 2204 may involve determining a set of relations between indications of presence of the thermo-active components or the non-thermo-active components within locations of the target deformation shape, orientations of the thermo-active components where present, and deformation capabilities of the thermo-active components where present.

Block 2206 may involve providing, to an optimization solver application, the specification, the set of relations, and instructions to minimize a curvature-based error function between a current deformation shape of the substance and the target deformation shape.

Block 2208 may involve receiving, from the optimization solver application, values of the presence of the thermo-active components or the non-thermo-active components within the locations of the target deformation shape and the orientations of the thermo-active components where present, such that the substance can attain the target deformation shape in response to exposure to a temperature change when in a non-deformed state.

Block 2210 may involve providing, to a manufacturing system, a digital model of the substance in the non-deformed state including the values, wherein the manufacturing system is configured to produce a physical representation of the substance in the non-deformed state.

In some embodiments, the substance includes biological tissue, and wherein the set of relations includes a constraint that the biological tissue is subject to a predetermined strain. This is a depiction of intrinsic mechanical properties.

In some embodiments, the manufacturing system includes a direct ink writing printing apparatus. These embodiments may involve causing the direct ink writing printing apparatus to produce the physical representation of the substance in the non-deformed state.

In some embodiments, the thermo-active components include liquid crystal elastomer components.

In some embodiments, the orientations are average orientations of groups of the liquid crystal elastomer components within the substance.

In some embodiments, the orientations are selected from a continuous range of angles.

In some embodiments, a predetermined total volume of the substance is a constraint on the set of relations.

### F. Example Technical Improvements

The embodiments herein provide a technical improvement in the topology optimization and fabrication of LCE structures by employing a continuous director orientation scheme, rather than limiting the design to a small set of discrete candidate orientations. In discretized approaches, the optimization algorithm can only assign directors from a finite set of predetermined angles, which inherently restricts the achievable morphologies and mechanical responses of the resulting structure. By contrast, the disclosed continuous orientation method allows the director field at each point in the LCE domain to assume any value within a full angular range, thereby expanding the optimization search space to include a continuum of possible configurations. This expanded design space enables the generation of highly multifunctional LCE structures with superior deformation accuracy, actuation performance, and adaptability relative to designs constrained by discrete orientation choices.

In addition to performance gains, the continuous orientation scheme provides a manufacturing advantage, particularly for additive manufacturing processes such as DIW. A smoothly varying, continuous director pattern supports the creation of unified and uninterrupted printing toolpaths across the entire domain. This eliminates the need to segment the print into multiple subdomains, avoiding both the complexity of generating separate toolpaths and the mechanical drawbacks of interface regions subject to prestrained tensile forces. The uninterrupted paths further reduce unwanted ink oozing and deposition defects that often occur when the printhead travels between noncontiguous regions, thereby improving dimensional fidelity and material property uniformity in the fabricated part. These improvements are rooted in the integration of advanced computational design with practical fabrication constraints, and result in LCE devices that exhibit enhanced functional precision, reliability, and manufacturability beyond what was possible with prior discretized-orientation methods.

### V. Computational Morphogenesis for LCE Metamaterial

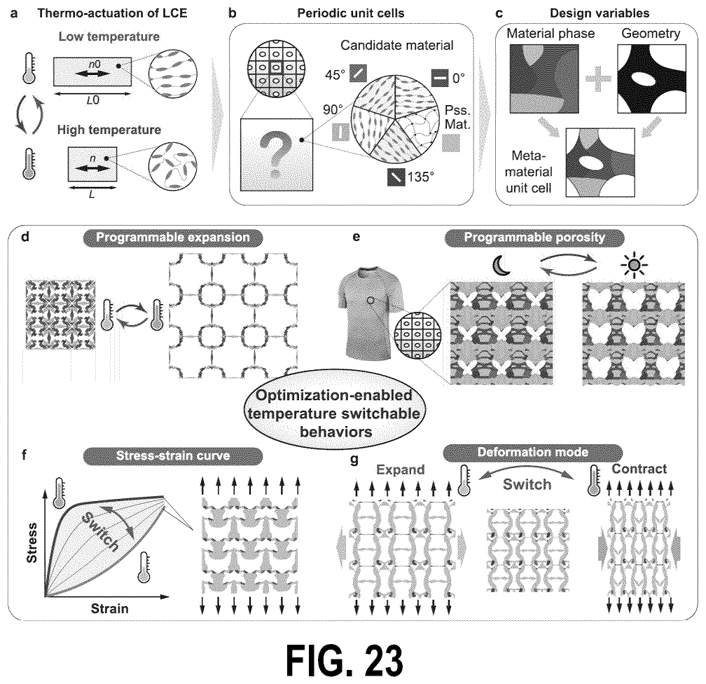

This set of embodiments focuses on planar LCE composite metamaterials comprised of 2D periodic unit cells under the plane-stress condition as illustrated in FIG. 23 part b. The deformation of the cells under thermal or mechanical loading is assumed to be also periodic and absent of symmetry breaking, which allows a focus on designing the behavior of a single unit cell under periodic boundary conditions. Particularly, emphasis is on LCE metamaterials with programmable spontaneous area expansion under temperature rise while satisfying a minimal stiffness requirement, which finds applications in, for example, self-deployable structures.

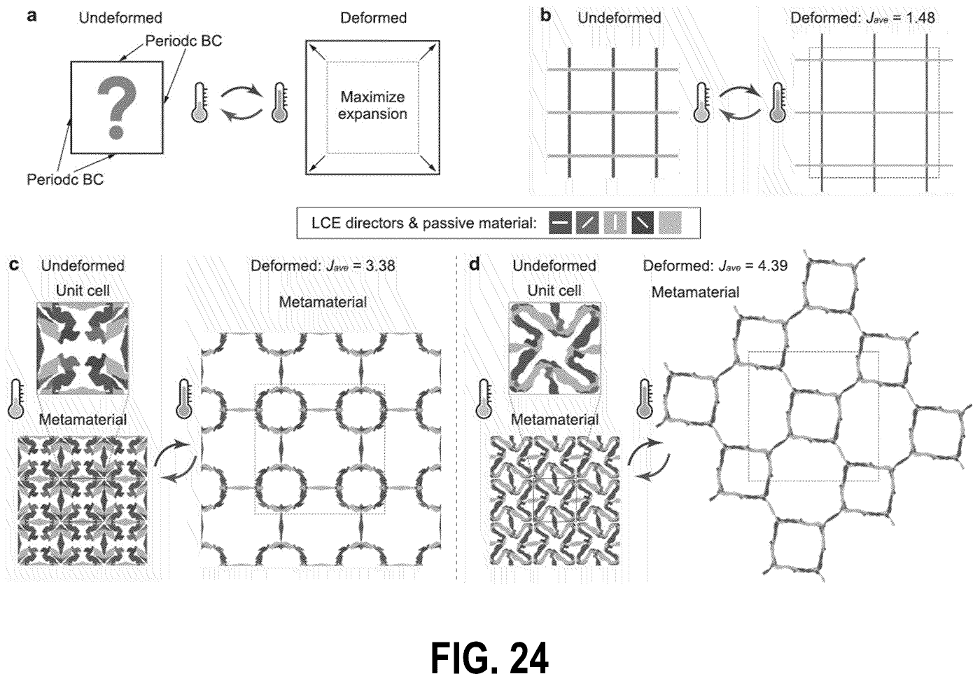

A heuristic design for maximum expansion can align the LCE director in the X and Y direction as shown in FIG. 24 part b to directly exploit the LCE's extension perpendicular to the director. The expansion is driven solely by the LCE material behavior instead of geometry or kinematics as the members remain straight after the deformation. A topology optimization is then used to produce an optimized unit cell with axial symmetry as shown in FIG. 24 part c together with the undeformed and deformed 3×3 assembly. The optimized metamaterial produces an expansion ratio of 3.38—more than twice larger than the heuristic design. The unit cell features highly curved members and complex LCE distributions with little passive material. When heated, the LCE actuates locally and straightens the curved members, significantly enlarging the metamaterial as demonstrated in the deformed assembly in FIG. 24 part c. Unlike the heuristic design, the optimized design exploits both the LCE's local actuation and global geometric nonlinearity (large rotation) to maximize expansion.

### A. Programmable Spontaneous Area Change of Opening with Unaltered Overall Size

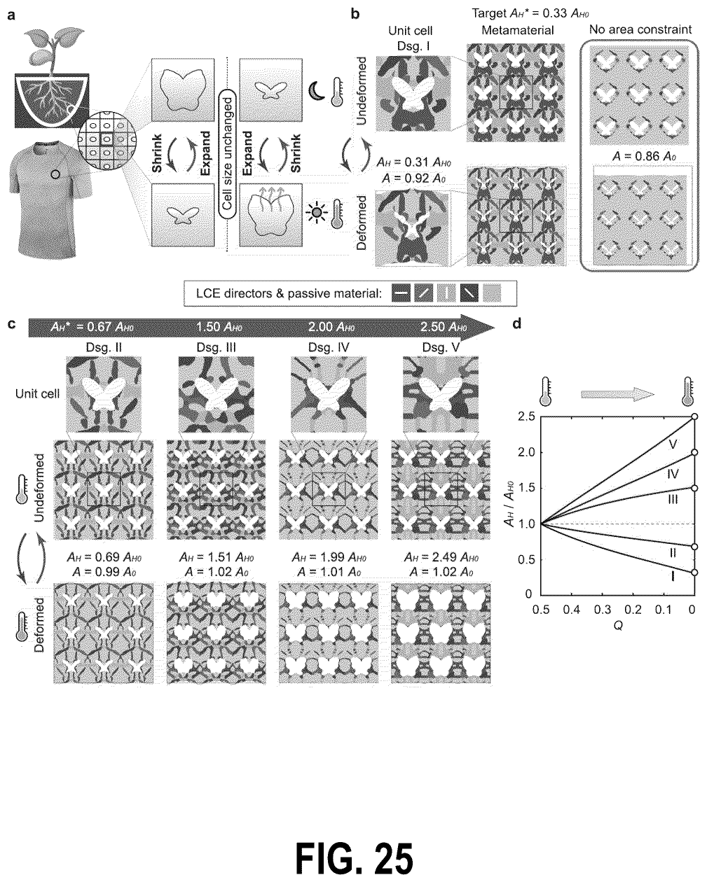

The area change of an opening in an LCE metamaterial unit cell can be programmed, which can benefit applications such as smart evaporation control for plants or human thermal management as indicated in FIG. 25 part a. For these applications, the porous opening of the material would expand or contract in a controllable fashion upon temperature variations. While the opening morphs, the total area of the unit cell (and hence the product's size) should (according to some applications) maintain its size under temperature fluctuations. As an example, smart wearable fabrics for active thermal management change their porosity but not the overall size as the latter would lead to shrinking or sagging and cause discomfort for the wearer. The seemingly contradictory temperature-sensitive opening and temperature-insensitive overall size cannot practically be achieved by heuristics or experience. Here, with the inverse design framework, both requirements can be met, and a wide range of targeted area changes of the opening, including different levels of contraction and expansion, can be accurately realized without severely perturbing the overall size.

The obtained design and its deformed configurations in both unit cell and assembly are shown in FIG. 25 part b. The design features rather complex LCE distributions, with X-director LCE members aligned in the Y direction, and Y-director LCE aligned in the X direction. LCEs with the other two directors are placed mainly on the diagonals of the unit cell. When heated, the deformed opening's area A_{H} contracts to 0.31 of the undeformed A_{H0}, which accurately achieves the target ratio of 0.33.

The inverse design facilitates the precise realization of a broad range of thermally induced area changes for the opening while retaining the unit cell's overall size. This is demonstrated in FIG. 25 part c, which shows the optimized design with target opening area

$${A}_{H}^{*} = 0.67 , 1.5 , 2. and 2.5 times {A}_{H 0} .$$

All designs accurately achieve the target opening areas with relative errors

$$( {A}_{H} - {A}_{H}^{*} ) / {A}_{H}^{*}$$

less than 6% while retaining their overall size with less than 2% variations. The optimized LCE distributions reveal qualitative trends. As A_{H}* grows, the orientation of the X-director LCE members change from vertical to horizontal, as the vertical ones squeeze the opening and the horizontal ones pull and expand the opening. In a similar trend, Y-director LCE members change from horizontally oriented to vertically oriented. With these embodiments, it is possible to achieve a zero deformed area with a closed opening.

### B. Thermally Switchable Nonlinear Stress-Strain Relations

Temperature change can be used as a switch that alters the effective stress-strain relation and deformation mode of LCE metamaterial in a programmable fashion. With the proposed LCE inverse design framework, significant changes can be precisely programmed in mechanical responses under temperature variations while retaining the initial size or length at different temperatures. The focus is on programming temperature-switchable effective stress-strain relations for LCE metamaterials. Based on this, different target stress-strain curves can be assigned for the inverse design under different temperatures.

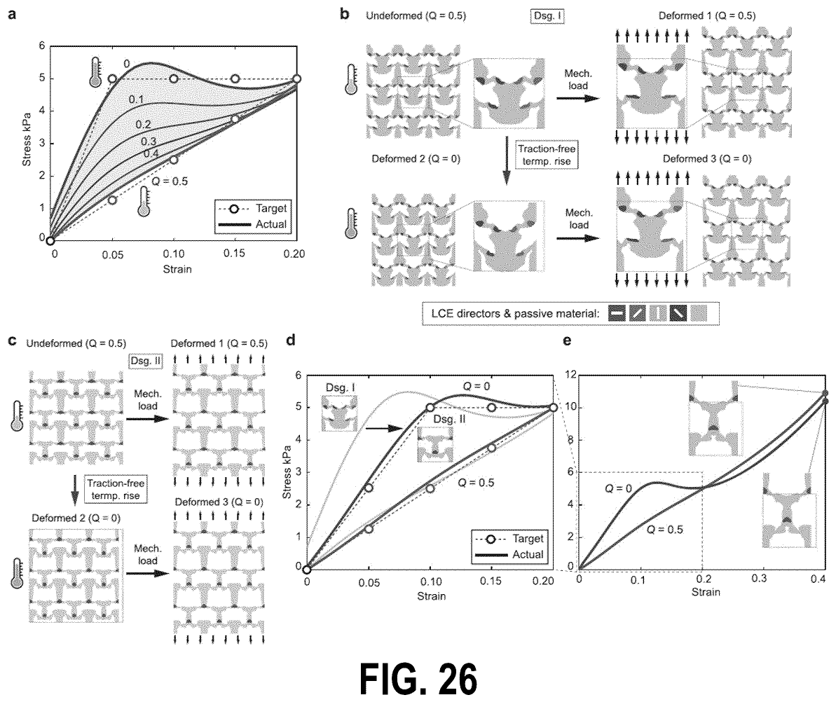

The optimized metamaterial (Dsg. I) and its configurations at four states of initial at low temperature (undeformed), mechanical load at low temperature (Deformed 1), spontaneous deformation at high temperature (Deformed 2), and subsequent mechanical load at high temperature (Deformed 3) are shown in FIG. 26 part b. The design has four branches and a bulk center connected through two pairs of slender beams where the LCE is allocated. When loaded vertically at the low temperature and deformed into the Deformed 1 configuration in FIG. 26 part b, the metamaterial accurately achieves the prescribed linear stress-strain relation as indicated by the dark curve in FIG. 26 part a. When heated to Q=0, the metamaterial shrinks in the lateral direction (X direction) due to LCE actuation while largely retaining the initial size in the loading direction (Y direction) as shown in the Deformed 2 configuration in FIG. 26 part b because of the length-preserving constraint. When loaded mechanically at the high temperature, the metamaterial deforms into the Deformed 3 configuration in FIG. 26 part b and also accurately produces the prescribed bi-linear force plateau behavior as demonstrated by the top curve in FIG. 26 part a with mild fluctuations over the plateau. The large behavioral change is mainly caused by the thermally induced spontaneous configuration change before the mechanical loading.

The stress-strain relations at intermediate temperatures, i.e., those corresponding to Q=0.4, 0.3, 0.2, and 0.1, are also evaluated as shown in the curves between the Q=0.5 and Q=0 of FIG. 26 part a. The curves demonstrate a continuous variation from the linear to the plateau curves as the temperature gradually rises. This provides a wide spectrum of thermally tunable nonlinear behaviors that further broaden the applicability of the LCE metamaterial.

### C. Thermally Switchable Deformation Mode

The inverse design method also allows for programming dissimilar deformation modes of mechanical loading in two temperatures while retaining their initial lateral size under pure temperature variations. This capacity is demonstrated by realizing maximized opposite lateral deformation (expansion versus contraction) of a metamaterial unit cell under uniaxial vertical loading at two temperatures. To this end, a large positive target lateral strain is assigned at the low temperature and a large negative target is assigned at the high temperature.

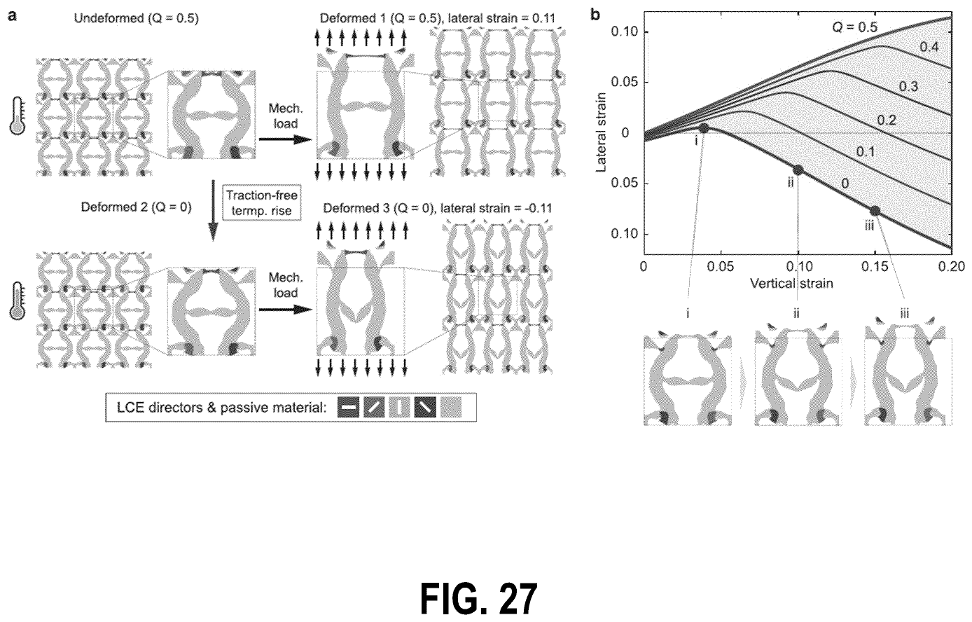

The optimized metamaterial unit cell and assembly are shown in FIG. 27 part a with the three deformed configurations under mechanical and thermal loading. As seen in the two deformed configurations under mechanical loading, the metamaterial achieves the targeted behavior of expanding laterally at the low temperature (Deformed 1) and contracting at the high temperature (Deformed 3). The magnitudes of both lateral strains are 0.11, more than half of the applied 0.2 strain. Meanwhile, the unit cell largely retains its initial width under purely temperature rise seen in the Deformed 2 (Q=0) configuration of FIG. 27 part a.

### D. Example Technical Improvements

The disclosed embodiments provide technical improvements in LCE composite metamaterials by integrating a nonlinear LCE material model with a topology optimization framework tailored for specific thermomechanical behaviors. First, optimized unit cell geometries and LCE director orientations produce complex curved members that straighten under heating, exploiting both local actuation and global geometric nonlinearity to achieve temperature-induced area expansion ratios that are more than twice those of heuristic designs while maintaining requisite stiffness. Second, the framework enables precise programming of opening area changes within a unit cell over a broad range while keeping total unit cell area variation under 2%, meeting functional porosity requirements without altering overall dimensions. Third, the method produces temperature-switchable nonlinear stress-strain relations, such as linear behavior at low temperature and a bi-linear plateau at high temperature, by inducing thermally driven pre-strain that reconfigures internal member orientations before loading, allowing significant mechanical property changes without changing size. Fourth, the approach yields temperature-switchable deformation modes, programming lateral expansion under load at low temperature and lateral contraction at high temperature, with little or no change in unloaded lateral size, by exploiting structural elements that resist or buckle depending on pre-strain state. These results provide greater actuation amplitude, programmable multi-objective performance, and thermally reconfigurable mechanical responses not achievable with conventional forward-design methods.

There are numerous practical uses of these embodiments. For example, self-deployable aerospace structures could leverage high expansion ratios to unfold large surfaces from compact stowed volumes without motors or hinges. Wearable thermal-management textiles could use the programmable opening-area change to regulate breathability or insulation without altering garment fit. Temperature-switchable stress-strain relations could be employed in impact protection systems or vibration isolators that stiffen or soften depending on environmental conditions. Switchable deformation modes could benefit soft robotic grippers or adaptive joints that alter their motion paths with temperature, enabling multifunctional operation from a single structure. In each case, the ability to achieve large, precise, and reversible changes in performance while maintaining overall size or shape simplifies integration and reduces reliance on external actuators or complex mechanical assemblies.

### VI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of
the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
obtaining a specification of a target deformation shape for a substance, wherein the substance has a plurality of material control points with respective curvatures and arc lengths defining the target deformation shape, and wherein the substance includes thermo-active components and non-thermo-active components;
determining a set of relations between indications of presence of the thermo-active components or the non-thermo-active components within locations of the target deformation shape, orientations of the thermo-active components where present, and deformation capabilities of the thermo-active components where present;
providing, to an optimization solver application, the specification, the set of relations, and instructions to determine values of the presence of the thermo-active components or the non-thermo-active components within the locations of the target deformation shape and the orientations of the thermo-active components where present, such that the substance can attain the target deformation shape in response to exposure to a temperature change when in a non-deformed state;
receiving, from the optimization solver application, the values as determined; and
providing, to a manufacturing system, a digital model of the substance in the non-deformed state including the values, wherein the manufacturing system is configured to produce a physical representation of the substance in the non-deformed state.

2. The computer-implemented method of claim 1, wherein the manufacturing system includes a 3D or 4D printing apparatus, the computer-implemented method further comprising:
causing the 3D or 4D printing apparatus to produce the physical representation of the substance in the non-deformed state.

3. The computer-implemented method of claim 1, wherein the thermo-active components include liquid crystal elastomer components.

4. The computer-implemented method of claim 3, wherein the orientations are average orientations of groups of the liquid crystal elastomer components within the substance.

5. The computer-implemented method of claim 4, wherein the orientations are selected from 2-8 predetermined angles.

6. The computer-implemented method of claim 1, wherein the orientations become isotropic when the substance is heated to be above a transition temperature.

7. The computer-implemented method of claim 1, wherein the set of relations also involve a volume of the thermo-active components and a further volume of the non-thermo-active components.

8. The computer-implemented method of claim 1, wherein a predetermined total volume of the substance is a constraint on the set of relations.

9. The computer-implemented method of claim 1, wherein the optimization solver application is configured to determine the values using an iterative process, and wherein an iteration of the iterative process comprises:
decomposing the substance into a material phase distribution on a finite element mesh;
determining, based on the finite element mesh of the substance, the values of the presence of the thermo-active components or the non-thermo-active components within the locations of the target deformation shape and the orientations of the thermo-active components where present and deformation capabilities of the thermo-active components where present; and
based on a gradient between the values and previous values from previous iterations of the iterative process, determining parameters for a new material phase distribution on the finite element mesh to be used in a subsequent iteration of the iterative process.

10. The computer-implemented method of claim 1, wherein the substance is formed as a solid strip with a length of at least 10 times its height and thickness.

11. The computer-implemented method of claim 1, wherein the substance is formed as planar sheet with the thermo-active components positioned on its edges.

12. The computer-implemented method of claim 1, wherein the optimization solver application is configured to attempt to maximize the deformation capabilities of the thermo-active components.

13. A computer-implemented method comprising:
obtaining a specification of a target deformation shape for a substance, wherein the substance has a plurality of material control points with respective curvatures and arc lengths defining the target deformation shape, and wherein the substance includes thermo-active components and non-thermo-active components;
determining a set of relations between indications of presence of the thermo-active components or the non-thermo-active components within locations of the target deformation shape, orientations of the thermo-active components where present, and deformation capabilities of the thermo-active components where present;
providing, to an optimization solver application, the specification, the set of relations, and instructions to minimize a curvature-based error function between a current deformation shape of the substance and the target deformation shape;
receiving, from the optimization solver application, values of the presence of the thermo-active components or the non-thermo-active components within the locations of the target deformation shape and the orientations of the thermo-active components where present, such that the substance can attain the target deformation shape in response to exposure to a temperature change when in a non-deformed state; and
providing, to a manufacturing system, a digital model of the substance in the non-deformed state including the values, wherein the manufacturing system is configured to produce a physical representation of the substance in the non-deformed state.

14. The computer-implemented method of claim 13, wherein the substance includes biological tissue, and wherein the set of relations include a constraint that the biological tissue is subject to a predetermined strain.

15. The computer-implemented method of claim 13, wherein the manufacturing system includes a direct ink writing printing apparatus, the computer-implemented method further comprising:
causing the direct ink writing printing apparatus to produce the physical representation of the substance in the non-deformed state.

16. The computer-implemented method of claim 13, wherein the thermo-active components include liquid crystal elastomer components.

17. The computer-implemented method of claim 16, wherein the orientations are average orientations of groups of the liquid crystal elastomer components within the substance.

18. The computer-implemented method of claim 13, wherein the orientations are selected from a continuous range of angles.

19. The computer-implemented method of claim 13, wherein a predetermined total volume of the substance is a constraint on the set of relations.

20. A non-transitory computer-readable medium, storing program instructions that, when executed by one or more processors of a computing system, cause the computing system to perform operations comprising:
obtaining a specification of a target deformation shape for a substance, wherein the substance has a plurality of material control points with respective curvatures and arc lengths defining the target deformation shape, and wherein the substance includes thermo-active components and non-thermo-active components;
determining a set of relations between indications of presence of the thermo-active components or the non-thermo-active components within locations of the target deformation shape, orientations of the thermo-active components where present, and deformation capabilities of the thermo-active components where present;
providing, to an optimization solver application, the specification, the set of relations, and instructions to determine values of the presence of the thermo-active components or the non-thermo-active components within the locations of the target deformation shape and the orientations of the thermo-active components where present, such that the substance can attain the target deformation shape in response to exposure to a temperature change when in a non-deformed state;
receiving, from the optimization solver application, the values as determined; and
providing, to a manufacturing system, a digital model of the substance in the non-deformed state including the values, wherein the manufacturing system is configured to produce a physical representation of the substance in the non-deformed state.
